(19) United States
(12) Patent Application Publication
(10) Pub. No.: US 2010/0162630 A1
(43) Pub. Date: Jul. 1, 2010

(54) Door safety systems and methods

(76) Inventor: Youngtack Shim, Port Moody (CA)

Correspondence Address: Youngtack Shim, 155 Aspenwood Drive, Port Moody, BC, V3H 5A5, CA

(21) Appl. No.: 12/318,352

(22) Filed: Dec. 29, 2008

(51) Int. Cl. E06B 7/28; E06B 3/00

(52) U.S. Cl. 49/383; 49/506

(57) ABSTRACT

The present invention generally relates to door safety systems incorporated into a gap formed between a rear end of a door and a matching frame and covering the gap while the door is open such that an user may protect his or her fingers or toes from being caught in the gap when the door may be shut unexpectedly. More particularly, the present invention relates to various covers of such systems which may extend across and cover at least a portion of the gap, may fill such a portion of the gap or otherwise isolate such a portion of the gap when the door is open. As will be described below, such door safety systems of this invention may be practiced by numerous embodiments each including one or more movable covers which may cover the portion of the gap in relation to movements of the doors and/or presence of an object in such a gap. The present invention also relates to various methods of covering the gap using such covers and various processes for providing the covers.

### CROSS-REFERENCES TO RELATED APPLICATIONS

The present application claims an earlier invention date of a Disclosure Document entitled the same, deposited in the U.S. Patent and Trademark Office (the “Office”) on Dec. 28, 2006 under the Disclosure Document Deposit Program (the “DDDP”) of the Office, and bearing a Ser. No. 610,505 which is to be incorporated herein in their entirety by reference.

### FIELD OF THE INVENTION

The present invention generally relates to door safety systems incorporated into a gap formed between a rear end of a door and a matching frame and covering the gap while the door is open such that an user may protect his or her fingers or toes from being caught in the gap when the door may be shut unexpectedly. More particularly, the present invention relates to various covers of such systems which may extend across and cover at least a portion of the gap, may fill such a portion of the gap or otherwise isolate such a portion of the gap when the door is open. As will be described below, such door safety systems of this invention may be practiced by numerous embodiments each including one or more movable covers which may cover the portion of the gap in relation to movements of the doors and/or presence of an object in such a gap. The present invention also relates to various methods of covering the gap using such covers and various processes for providing the covers.

### BACKGROUND OF THE INVENTION

Doors are used to form and close an access. For example, FIGS. 1A and 1B are perspective views of a conventional door (prior art) which are disposed respectively in its closed position and in its open position. An exemplary door 10 has a front surface 11F and a rear surface 11R and defines a front end 12F and a rear end 12R, where a handle or a door knob 13 is disposed closer to the front end 12F. The door 10 is arranged to movably disposed inside a matching frame 20 such that the rear end 12R of the door 10 opposes a coupling end 22 of the frame 20. In addition, a hinge 23 is installed between the rear end 1 2R of the door 10 and coupling end 22 of the frame 20 so that the door 10 may rotate or pivot between its closed position (see FIG. 1A) and its open position (see FIG. 1B) about an axis of rotation which generally coincides with a longitudinal axis of the hinge 23.

Although such conventional doors have been in use for centuries, they have suffered from a few problems. For example, a door-frame assembly of the figures forms a gap 15 between the rear and coupling ends 12R, 22. Such a gap 15 may correspond to a small clearance when the door 10 is shut in its closed position but may significantly increase its size as the door 10 moves toward its open position. When an user inadvertently places his or her fingers or toes in the gap 15 and closes such a door without being aware of the danger, the fingers or toes may get broken or crushed. Although some conventional doors are equipped with some types of safety devices near their front ends, such gaps formed between the rear ends of the doors and the coupling ends of the matching frames have been left open for centuries, while inviting more injuries.

Therefore, there is a need for door safety systems which may be capable of covering, filling, isolating, and/or blocking access to such a gap, thereby preventing the body parts from being caught in the gap. There also is a need for various methods of incorporating such door safety systems into conventional doors, frames, and/or their assemblies without degrading or mitigating intended functions of such doors, frames, and assemblies.

### SUMMARY OF THE INVENTION

The present invention generally relates to door safety systems incorporated into a gap formed between a rear end of a door and a matching frame and covering the gap while the door is open such that an user may protect his or her fingers or toes from being caught in the gap when the door may be shut unexpectedly. More particularly, the present invention relates to various covers of such systems which may translate, rotate, and/or pivot across (or over) and cover at least a portion of the gap, may fill or occupy such a portion of the gap and block access to the gap, or may otherwise isolate such a portion of the gap when the door is or kept open. As will be described in detail below, the door safety systems of the present invention may be practiced through numerous embodiments each including at least one movable or deformable cover which may cover the portion of the gap in temporal, spatial or complementary relation to opening and closing movements of the door and/or presence or absence of an object inside the gap. This invention also relates to various door or frame assemblies incorporating such door safety systems therein and door-frame assemblies incorporating therein such door safety systems. The present invention also relates to various methods of providing such deformable and/or movable covers, various methods of incorporating such covers into the door, frame, and door-frame assemblies, and various methods of covering such a portion of the gap by such covers. The present invention further relates to various processes for fabricating such movable and/or deformable covers, door assemblies, frame assemblies, and door-frame assemblies.

Various door safety systems of the present invention offer numerous benefits. For example, such systems may protect an user from physical injuries in case his or her fingers or toes should be caught in the gap and crushed by the door when the door is unexpectedly shut to close. By covering the gap, filling the gap or otherwise blocking access to the gap, the door safety systems may make it practically impossible for the user to place his or her body parts inside such a gap, thereby preventing such physical injuries. Such door safety systems may be shaped and/or sized to be incorporated into the gap so that at least substantial portions thereof may be hidden between the door and frame when the door is closed. Alternatively, such systems may be shaped and/or sized to be disposed outside the door and/or frame so that their covers may always cover, block access to, and/or isolate the gap regardless of whether the door is open or closed. The door safety systems may be incorporated to the door assemblies, frame assemblies or door-frame assemblies in a factory so that all the user has to do is to install such assemblies. In the alternative, such door safety systems may be provided to be retrofit into existing doors and/or frames as well.

Various door safety systems of this invention may be readily applied to conventional revolving or rotating doors of structures such as houses, buildings, and so on, so as to cover, fill, block access to, and/or isolate at least a portion of the gap. When desired, the door safety systems may be applied to conventional sliding doors and cover, fill, block access to, and/or isolate at least a portion of the gap as well, where such a gap is formed as such doors laterally move away from their closed positions. Various door safety systems of this invention may also be applied to other conventional doors as long as such doors may form the gap as they may move from their closed positions to their open positions. For example, such systems may be implemented to doors of vehicles including automobiles, airplanes, surface vessels, and so on. Such systems may also be incorporated into doors of other conventional articles such as cabinets, brief cases, luggage bags, boxes, and so on. In short, various door safety systems of this invention may be implemented to various articles which may open and close and may form the gap during such opening and/or closing movements.

In one aspect of the present invention, a door safety system for a door may be provided such that the door may be arranged to be movably coupled to a frame, to rotate between at least one open position and at least one closed position about a rotating axis defined with respect to such a frame, to define a rear end close to the rotating axis and a front end opposite to the rear end, and to form a gap between the frame and rear end of the door when the door moves away from the closed position.

In one exemplary embodiment of this aspect of the present invention, a system may include at least one cover member which may be arranged to operatively couple with the frame and/or door, to be disposed adjacent to the frame and/or door when the door may be disposed in the closed position. In one example, the cover member may be arranged to at least partially extend across the frame and rear end of the door when the door may move away from the closed position. In another example, the cover member may be arranged to cover at least a portion of the gap when the door may move away from the closed position. In another example, the cover member may be arranged to isolate at least a portion of the gap when the door may move away from the closed position. In another example, such a cover member may be arranged to fill at least a portion of the gap when the door may move away from the closed position. In yet another example, the cover member may be arranged to block access to at least a portion of the gap when the door may move away therefrom.

In another exemplary embodiment of this aspect of the present invention, a system may include at least one cover member which may operatively couple with the frame and/or door. In one example, at least a portion of the cover member may be arranged to remain folded when the door may be in the closed position and to be unfolded when the door may move away from the closed position, thereby covering (or isolating, filling, extending across, blocking access to) at least a portion of the gap by the unfolded portion thereof. In another example, at least a portion of the cover member may be arranged to remain rolled when the door may be in in the closed position and then to be unrolled when the door may move away from the closed position, thereby covering (or isolating, extending across, blocking access to, filling) at least a portion of the gap by the unrolled portion thereof. In another example, at least a portion of the cover member may be arranged to be stacked when the door may remain in the closed position and to be unstacked when the door may move away from the closed position, thereby covering (or isolating, filling, extending across, blocking access to) at least a portion of the gap by the unstacked portion thereof. In yet another example, at least a portion of the cover member may also be arranged to be disposed close to the frame and/or door when the door may be in the closed position and to pivot, rotate, and/or slide along with the door when the door may move away from the closed position, thereby covering (or isolating, filling, extending across, blocking access to) at least a portion of the gap by the rotating, pivoting, and/or sliding portion of the cover member. In another example, at least a portion of the cover member may be arranged to define a smaller shape (or size) between the door and frame when the door may be in the closed position and thereafter to deform while changing a configuration into a bigger shape (or size) when the door may move away from the closed position, thereby covering (or isolating, filling, extending across, blocking access to) at least a portion of such gap by the deformed portion thereof.

In another exemplary embodiment of this aspect of the present invention, a system may include at least one cover member which may be arranged to operate between at least one off-state and at least one on-state based on a preset temporal relation with the door moving between the closed and open positions. At least a portion of such a cover member may be arranged be disposed close to the frame and/or door in the off-state and to cover (or isolate, fill, extend across, block access to) at least a portion of the gap in the on-state. Such preset temporal relation may be arranged to at least partially control timings of the operation of the cover member between the states and timings of movements of the door between the positions.

In another exemplary embodiment of this aspect of the present invention, a system may include at least one cover member which may be arranged to operate between at least one off-state and at least one on-state based upon a preset spatial relation with the door moving between the closed and open position. At least a portion of the cover member may be arranged be disposed close to the door and/or frame in the off-state and then to cover (or isolate, fill, extend across, block access to) at least a portion of the gap in the on-state. Such preset spatial relation may be arranged to at least partially control paths of the cover member between the states and paths of movements of the door between the positions.

In another exemplary embodiment of this aspect of the present invention, a system may include at least one cover member which may be arranged to operate between at least one off-state and at least one on-state through at least one cover driving force which may be applied thereto according to a preset complementary relation between the cover driving force and at least one door driving force moving the door between the closed and open positions. At least a portion of the cover member may be arranged be disposed adjacent to the frame an/or door in the off-state and to cover (or isolate, fill, extend across, block access to) at least a portion of such gap in the on-state. Such complementary relation may be arranged to at least partially control timings, directions, and/or amplitudes of operations of the cover member between the off- and on-states as well as timings, directions, and/or amplitudes of movements of the door between the closed and open positions.

In another exemplary embodiment of this aspect of the present invention, a system may include at least one cover member which may be arranged to be operatively coupled to the frame and/or door. In one example, at least a portion of such a cover member may be arranged to be hidden between the rear end of the door and the frame when the door may be in the closed position, and to be exposed in order to cover (or isolate, fill, extend across, block access to) at least a portion of such gap when the door may move away from the closed position. In another example, at least a portion of such a cover member may be arranged to be disposed out of the frame and/or rear end of the door when the door may be in the closed position, and to change its configuration in order to cover (or isolate, fill, extend across, block access to) at least a portion of the gap when the door may move away from the closed position.

In another exemplary embodiment of this aspect of the present invention, a system may include at least one cover member. In one example, the cover member may be arranged to form a movable or fixed coupling with the door, to be disposed close to the frame and/or door when the door may be in the closed position, and then to cover (or isolate, fill, extend across, block access to) at least a portion of the gap while maintaining the coupling when the door may move away from the closed position. In another example, such a cover member may be arranged to form a movable or fixed coupling with the frame, to be disposed adjacent to the frame and/or door when the door may be disposed in the closed position, and then to cover (or isolate, fill, extend across, block access to) at least a portion of the gap while keeping the coupling when the door may move away therefrom. In another example, the cover member may be arranged to form a movable or fixed coupling with each of the frame and door, to be disposed adjacent to the frame and/or door when the door may be in the closed position, and to cover (or isolate, fill, extend across, block access to) at least a portion of the gap while keeping the coupling with the each of the frame and door when the door moves away therefrom.

In another aspect of the present invention, a door safety system of a door may be provided so that the door may be arranged to movably couple with a frame, to rotate about a rotating axis defined on (or near) the frame between at least one open position and at least one closed position, to define a front surface, a rear surface, a rear end disposed close to the rotating axis, and a front end opposite to the rear end, and to form a gap between the frame and rear end of the door when such a door may move away from the closed position toward the open position.

In one exemplary embodiment of this aspect of the present invention, a system may include at least one cover member which may be arranged to couple with the frame and/or door and to operate from at least one off-state to at least one on-state and vice versa when such a door may respectively move from the closed position to the open position and vice versa. At least a portion of such a cover member may be arranged to be disposed close to the frame and rear end of the door in the off-state and then to cover (or isolate, fill, extend across, block access to) at least a portion of such gap in the on-state.

In another exemplary embodiment of this aspect of the present invention, a system may include at least one foldable cover. In one example, a single foldable cover may be arranged to be coupled to the frame and/or door, to be in a folded state when the door may be in the closed position, and then to move to an unfolded state when the door may move away from the closed position, thereby covering (or extending across, filling, blocking access to, isolating) at least a portion of such gap. In another example, a system may also include a housing arranged to couple with the frame and/or door. Such a single foldable cover may then be arranged to be folded inside such a housing when the door may be in the closed position and to move out of the housing when the door may move away from the closed position, thereby covering (or extending across, filling, blocking access to, isolating) at least a portion of the gap. In another example, the system may instead include multiple foldable covers which may be arranged to couple with the door and/or frame, where at least one of the covers may be arranged to remain in a folded state when the door may be in the closed position and then to move to an unfolded state when the door may move away from the closed position, thereby covering (or filling, extending across, isolating, blocking access to) at least a portion of the gap. In yet another example, the system may also include a housing arranged to couple with the frame and/or door. At least one of the multiple foldable covers may then be arranged to remain in the housing when the door may be in the closed position and then to move out of the housing when the door may move away from the closed position, thereby covering (or isolating, extending across, blocking access to, filling) at least a portion of such gap.

In another exemplary embodiment of this aspect of the present invention, a system may include at least one stackable cover. In one example, the system may include a single stackable cover which may be arranged to be coupled to the frame and/or door, to be disposed in a stacked state when the door may be in the closed position, and then to move to an unstacked state when the door may move away from the closed position, thereby covering (or extending across, blocking access to, isolating, filling) at least a portion of the gap. In another example, the system may include a housing and a single stackable cover. The housing may be arranged to couple with the frame and/or door, while the single stackable cover may be arranged to be stacked in the housing when the door may be in the closed position and then to move out of the housing when the door may move away from the closed position, thereby covering (or extending across, filling, blocking access to, isolating) at least a portion of such gap. In another example, the system may include multiple stackable covers which may be arranged to be coupled to the door and/or frame. At least one of the covers may be arranged to be in a stacked state when the door may be in the closed position, and then to move to an unstacked state when the door may move away therefrom, thereby covering (or isolating, extending across, blocking access to, filling) at least a portion of the gap. In another example, the system may include a housing and multiple stackable covers. The housing may be arranged to couple with the frame and/or door, while at least one of such multiple stackable covers may be arranged to be in the housing when the door may be in the closed position, and to move out of the housing when the door may move away from the closed position, thereby covering (or isolating, extending across, blocking access to, filling) at least a portion of the gap.

In another exemplary embodiment of this aspect of the present invention, a system may include at least one rollable cover. In one example, the system may include a roller and a single rollable cover. The roller may be arranged to couple with the frame and/or door, while the single rollable cover may be arranged to remain in a rolled state when the door may be in the closed position, and to move to an unrolled state when such a door may move away from the closed position, thereby covering (or filling, extending across, blocking access to, isolating) at least a portion of the gap. In another example, the system may include a housing, a roller, and at least one rollable cover. The housing may be arranged to couple with the frame and/or door, and the roller may be disposed across the housing. The rollable cover may be arranged to be rolled around the roller when the door may be in the closed position, and then to roll out of the roller when the door may move away from the closed position, thereby covering (or extending across, filling, blocking access to, isolating) at least a portion of the gap.

In another exemplary embodiment of this aspect of the present invention, a system may include at least one slidable cover. In one example, the system may include a single slidable cover which may be arranged to couple with the frame and/or door, to be disposed close to the the frame and/or door when the door may be in the closed position, and to slide along at least a portion of the gap when the door may move away therefrom, thereby covering (or extending across, isolating, blocking access to, filling) the portion of the gap. In another example, the system may have a housing and a single slidable cover. The housing may be arranged to couple with the frame and/or door, while the slidable cover may be arranged to be disposed in the housing when the door may be in the closed position, and then to slide out of the housing when the door may move away therefrom, thereby covering (or extending across, filling, blocking access to, isolating) at least a portion of the gap. In another example, such a system may include multiple slidable covers which may be arranged to couple with the frame and/or door. At least one of such covers may be arranged to be disposed near the frame and/or door when the door may be in the closed position and then to slide across at least a portion of the gap when the door may move away from the closed position, thereby covering (or isolating, filling, extending across, blocking access to) the portion of the gap. In another example, the system may include a housing and multiple slidable covers. The housing may be arranged to be coupled to the frame and/or door, while at least one of such multiple slidable covers may be arranged to remain in the housing when the door may be in the closed position and then to slide out of such a housing when the door may move away from the closed position, thereby covering (or isolating, extending across, blocking access to, filling) at least a portion of the gap.

In another exemplary embodiment of this aspect of the present invention, a system may include at least one deformable cover which may be arranged to be coupled to the door and/or frame. In one example, at least a portion of the cover may be arranged to be squeezed or compressed between the frame and rear end of the door to or in its stressed configuration in the off-state, and then to restore its unstressed configuration, thereby covering (or isolating, filling, extending across, blocking access to) at least a portion of the gap in the on-state. In another example, at least a portion of such a cover may instead be arranged to be disposed between the frame and rear end of the door in its unstressed configuration in the off-state, and to be expanded to its stressed configuration, thereby covering (or isolating, filling, extending across, blocking access to) at least a portion of the gap in the on-state.

In another aspect of the present invention, a door assembly may be provided for coupling with a matching frame and for moving between at least one closed position and at least one open position about a rotating axis which may be defined on (or near) the frame.

In one exemplary embodiment of this aspect of the present invention, an assembly may include a door and at least one cover member, where such a door may include a rear end for being disposed close to the rotating axis and a front end disposed opposite to the rear end, and may also be capable of forming a gap between the rear end and the frame when the door may be coupled to the frame and move away from the closed position. In one example, at least a portion of the cover member may be arranged to be incorporated into the rear end of the door and to cover (or isolate, extend across, fill, block access to) at least a portion of the gap when the door may be coupled to the frame and move away from the closed position. In another example, at least a portion of the cover member may also be arranged to be incorporated into the rear end of the door, to remain folded when the door may be coupled to the frame and disposed in the closed position, and to be unfolded when the door may move away from the closed position, thereby covering (or isolating, extending across, blocking access to, filling) at least a portion of the gap. In another example, at least a portion of the cover member may be arranged to be incorporated into the rear end of the door, to be stacked over another portion thereof when the door may be coupled to the frame and disposed in the closed position, and thereafter to be unstacked away from such another portion when the door may move away from the closed position, thereby covering (or isolating, blocking access to, filling, extending across) at least a portion of such gap. In another example, the cover member may include a roller, while at least a portion of the cover member may be arranged to be incorporated into the rear end of the door, to be rolled around the roller when the door may be coupled to the frame and disposed in the closed position, and then to be rolled out from such a roller when the door may move away from the closed position, thereby covering (or isolating, extending across, blocking access to, filling) at least a portion of the above gap. In another example, at least a portion of the cover member may be arranged to be incorporated into the rear end of the door, to be disposed adjacent to the door and/or frame when the door may be coupled to the frame and disposed in the closed position, and then to slide across at least a portion of the gap when the door may move away from the closed position, thereby covering (or isolating, extending across, filling, blocking access to) the portion of such gap. In another example, at least a portion of the cover member may be arranged to be incorporated into the rear end of the door, to define a smaller shape (or size) between the rear end and frame when the door may be coupled to the frame and disposed in the closed position, and thereafter to deform while changing the configuration to a bigger shape (or size) when the door may move away from the closed position, thereby covering (or blocking access to, isolating, extending across, filling) at least a portion of the gap.

In another exemplary embodiment of such an aspect of this invention, an assembly may have a door, a housing, and at least one cover member. The door may include a rear end for being disposed close to the rotating axis and a front end disposed opposite to the rear end and may also be capable of forming a gap between the rear end and frame when such a door may be coupled to the frame and moves away from the closed position, while at least a portion of the housing may be incorporated into the door. At least a portion of the cover member may be arranged to be disposed inside the housing when the door may be coupled to the frame and disposed in the closed position and then to move out of the housing so as to cover (or isolate, extend across, fill, block access to) at least a portion of the gap when the door may move away from the closed position.

In another aspect of the present invention, a frame assembly may be provided to couple with a matching door, where the door may be arranged to move between at least one closed position and at least one open position about a rotating axis defined on (or near) the frame and to have a rear end for being disposed adjacent to the rotating axis and a front end disposed opposite to such a rear end and may be capable of forming a gap between the rear end and frame when the door may be coupled to the frame and move away from the closed position.

In one exemplary embodiment of this aspect of the present invention, an assembly may include a frame and at least one cover member. The frame may be arranged to define an opening into which the door may be movably disposed. At least a portion of such a cover member may be incorporated into the frame, thereby covering (or filling, isolating, extending across, blocking access to) at least a portion of the gap when the door may couple with the frame and move away from the closed position.

In another exemplary embodiment of such an aspect of this invention, an assembly may have a frame and at least one cover member, where such a frame may be arranged to define an opening into which the door may be movably disposed and to form a coupling end which may be arranged to abut the rear end of the door when the door may couple with the frame. In one example, at least a portion of the cover member may be incorporated to the coupling end of the frame, to remain folded when the door may couple with the frame and disposed in the closed position, and then to be unfolded when the door may move away from the closed position, thereby covering (or isolating, extending across, filling, blocking access to) at least a portion of the gap. In another example, at least a portion of such a cover member may be arranged to be incorporated into the coupling end of the frame, to be stacked over another portion thereof when the door may be coupled to the frame and disposed in the closed position, and to be unstacked away from the another portion when the door may move away from the closed position, thereby covering (or extending across, filling, isolating, blocking access to) at least a portion of the gap. In another example, the system may include a roller, where at least a portion of the cover member may be incorporated into the coupling end of the frame, to be rolled around the roller when the door may couple with the frame and disposed in the closed position, and to be rolled out of such a roller when the door may move away from the closed position, thereby covering (or isolating, extending across, blocking access to, filling) at least a portion of the gap. In another example, at least a portion of the cover member may be incorporated into the coupling end of the frame, to be disposed close to the door and/or frame when the door may be coupled to the frame and disposed in the closed position, and to slide across at least a portion of the gap when such a door may move away from the closed position, thereby covering (or filling, isolating, extending across, blocking access to) at least a portion of the gap. In another example, at least a portion of the cover member may be incorporated to the coupling end of the frame, to define a smaller shape (or size) between the coupling end and rear end of the door when the door may be coupled to the frame and disposed in the closed position, and then to deform while changing the configuration into a bigger shape (or size) when such a door may move away from the closed position, thereby covering (or isolating, extending across, filling, blocking access to) at least a portion of the gap.

In another exemplary embodiment of this aspect of the present invention, such an assembly may include a frame, a housing, and at least one cover member. The frame may be arranged to form an opening into which the door may be movably disposed and to define a coupling end which may be arranged to abut the rear end of the door when such a door may be coupled to the frame. At least a portion of the housing may be incorporated into the frame. At least a portion of the cover member may be arranged to be disposed in the housing when the door may be coupled to the frame and disposed in the closed position, and then to move out of the housing in order to cover (or isolate, extend across, fill, block access to) at least a portion of the gap when such a door may move away from the closed position.

In another aspect of the present invention, a door-frame assembly may be provided to include a frame and a matching door which may be arranged to be disposed in the frame, to move between at least one closed position and at least one open position about a rotating axis formed on (or near) the frame, and to have a rear end for being disposed close to the rotating axis and a front end disposed opposite to the rear end. The door may also be capable of forming a gap between the rear end of the door and frame when the door may be coupled to the frame and move away from the closed position.

In one exemplary embodiment of this aspect of the present invention, an assembly may include at least one cover member at least a portion of which may be arranged to be incorporated to the rear end of the door and to cover (or isolate, extend across, fill, block access to) at least a portion of such gap when the door may be coupled to the frame and move away from the closed position. In a related embodiment, at least a portion of such a cover member may be arranged to be incorporated to the rear end of the door, to be folded when the door may be coupled to the frame and disposed in the closed position, and to be unfolded when the door may move away therefrom, thereby covering (or isolating, extending across, filling, blocking access to) at least a portion of the gap. In a related embodiment, at least a portion of such a cover member may be arranged to be incorporated into the rear end of such a door, to be stacked over another portion when the door may be coupled to the frame and disposed in the closed position, and then to be unstacked away from such another portion when the door may move away from the closed position, thereby covering (or filling, extending across, isolating, blocking access to) at least a portion of such gap. In another related embodiment, such a system may include a roller, and at least a portion of the cover member may be incorporated to the rear end of the door, to be rolled around such a roller when the door may be coupled to the frame and disposed in the closed position, and then to be rolled out from such a roller when the door may move away from the closed position, thereby covering (or isolating, extending across, blocking access to, filling) at least a portion of the gap. In another related embodiment, at least a portion of the cover member may be arranged to be incorporated into the rear end of the door, to be disposed adjacent to the door and/or frame when the door may be coupled to the frame and disposed in the closed position, and then to slide across at least a portion of the gap when the door may move away from the closed position, thereby covering (or filling, isolating, extending across, blocking access to) the portion of such gap. In another related embodiment, at least a portion of the cover member may be arranged to be incorporated into the rear end of the door, to define a smaller shape (or size) between the rear end and frame when the door may be coupled to the frame and disposed in the closed position, and then to deform while changing the configuration to a bigger shape (or size) when the door may move away from the closed position, thereby covering (or isolating, extending across, blocking access to, filling) at least a portion of such gap.

In another exemplary embodiment of such an aspect of this invention, an assembly may have at least one housing and at least one cover member. The housing may be incorporated into the door and/or frame. At least a portion of the cover member may be arranged to be disposed in the housing when the door may be coupled to the frame and disposed in the closed position, and then to move out of the housing so as to cover (or isolate, extend across, fill, block access to) at least a portion of the gap when the door may move away from the closed position.

In another aspect of the present invention, a door-frame assembly may be provided.

In one exemplary embodiment of this aspect of the present invention, an assembly may include a frame and a door. The door may be arranged to be disposed in the frame, to move between at least one closed position and at least one open position about a rotating axis formed on (or near) the frame, to have a rear end for being disposed adjacent to the rotating axis and a front end disposed opposite to the rear end and. Such a door may also be capable of defining a gap between the frame and rear end of the door when the door may be coupled to the frame and move away from the closed position, and of defining a smaller gap between the frame and rear end when the door may move to the closed position, thereby preventing (or minimizing) a mechanical damage to an object disposed between such a frame and rear end when the door suddenly moves to the closed position.

In another exemplary embodiment of such an aspect of this invention, an assembly may have a frame, a door, as well as at least one cover member. The door may be arranged to be disposed in the frame, to operate between at least one closed position and at least one open position about a rotating axis provided on (or near) the frame, to have a rear end for being disposed close to the rotating axis and a front end disposed opposite to the rear end. Such a door may also be capable of defining a gap between the frame and rear end of the door when the door may couple with such a frame and move away from the closed position. The deformable cover may be disposed between the frame and rear end so as to prevent (or minimize) a mechanical damage onto an object disposed between the frame and rear end when the door suddenly moves to the closed position.

Embodiments of the above aspects of the invention may include one or more of the following features.

The cover member may be coupled to none, one or both of the door and frame. Such a cover member may include a first end and an opposing second end. The cover member may move between multiple off- and/or on-states.

The gap may be formed along an entire or at least a substantial portion of a height of the door and/or frame, and the cover member may be arranged to cover a lower portion, a middle portion or at least a substantial portion of the gap.

The first end may be coupled to the door, while the second end may be coupled to the frame. The first (or second) end may be fixedly coupled to the door (or frame) and move therewith. Such a first (or second) end may releasably couple with the door (or frame) and may be arranged to engage and disengage with the door (or frame).

The guide may guide and/or support at least one of the movements of the cover member. The guide may be fixedly disposed. Alternatively, the guide may be movably disposed in order to translate, rotate, slide, extend, and/or retract along with the cover member.

At least one of the movements of the cover member may be in the temporal relation with one or both of the movements of the door such that the cover member may move from one to the other of the states before (or as, when) the door may move from one to the other of the positions, that the cover member may continue to move from one to the other of the states for a preset period, may continue to move after (or as, when) the door may move from one to the other of the positions, and the like. The cover member may be mechanically coupled to the door and move at least substantially simultaneously with the door. The system may include at least one elastic unit and/or at least one recoil unit to control timings of at least one of the movements of the cover member. At least one of the movements of such a cover member may not be temporally related with one or both of the movements of the door.

At least one of the movements of the cover member may be in the spatial relation with the gap and/or at least one of the movements of the door such that the cover member may move along a path which may be at least partially determined by a path of the door. The cover member may mechanically couple with the door so as to move along an at least substantially similar or identical path as the door. The system may also include at least one conversion unit so that a path of the cover member may be different from a path of the door, where examples of such a conversion unit may be an elastic unit, a viscous unit, a gear unit, and the like. At least one of the movements of the cover member may not be spatially related with one or both of the movements of the door or with the gap.

At least one the movements of the cover member may be in the complementary relation with at least one of the movements of the door so that the cover member may move through a covering force and an uncovering force and that the door may move through an opening force and a closing force. At least one of such covering and uncovering forces may be generated in response to at least one of the opening and closing forces. The covering and uncovering forces may be an extension force and a compression force, vice versa. The covering and uncovering forces may be torques acting along opposite directions. One of the covering and uncovering forces may be generated through one of the opening and closing forces, while the other of the covering and uncovering forces may be generated by an user or the cover member. At least one of the forces of the cover member and/or door may be generated by an user, a recoil unit which may be capable of storing energy from the user through one of the movements and releasing the energy through the other of the movements, an actuator member, and the like. At least one of the movements of the cover member may not be complementarily related with one or both of the movements of the door or with the gap.

Deformation of the cover member may include the change in the configuration such as, e.g., a height, a length, a width, a thickness, an inner (or outer) radius (or diameter), an angle, a curvature, a slope, an orientation, an arrangement, a molecular or microscopic structure, a combination, and so on.

At least a portion of the cover member may be unfolded and cover the gap and may folded and uncover the gap respectively in the on- and off-states. Such a foldable cover member may include at least one foldable cover unfolding along a covering direction and folding along an uncovering direction which may be identical to or different from the covering direction. The cover member may also include multiple foldable covers which may also be coupled to each other by at least one elastic or non-elastic coupler. The foldable cover may be supported by a support and/or guided by a guide unit through one or both of the movements between the states.

At least a portion of the cover member may be unstacked and cover the gap and may also be stacked and uncover the gap respectively in the on- and off-states. The cover member may include at least one stackable cover unfolding in a covering direction and folding along an uncovering direction which may be identical to or different from the covering direction. Such a cover member may include multiple stackable covers which may couple each other by at least one elastic or non-elastic coupler. The stackable cover may be supported by a support and/or guided by a guide unit during one or both of its movements between the states.

At least a portion of the cover member may unroll out of the roller to cover the gap and may roll around the roller to uncover the gap respectively in the on- and off-states. Such a cover member may have at least one rollable cover unfolding in a covering direction and folding in an uncovering direction which may be identical to or different from the covering direction. The cover member may also include multiple rollable covers and rollers. Such a rollable cover may also be supported by a support and/or guided by a guide unit through one or both of its movements between the states.

At least a portion of the cover member may be arranged to slide out toward and cover the gap and then slide in away from and uncover the gap respectively in the on- and off-states. Such a cover member may include at least one slidable cover unfolding along a covering direction and folding along an uncovering direction which may be identical to or different from the covering direction. The cover member may have multiple slidable covers. The slidable cover may be supported by a support and/or guided by a guide unit through one or both of its movements between the states.

At least a portion of the cover member may be made of and/or include an elastic material so as to be stretched in one of such states and then to be unstretched in the other of the states. The cover member may include multiple covers of an identical dimension or different dimensions or of an identical type or different types. The system may also include multiple cover members each including the same or different covers.

At least one movement of the cover member between its off- and on-states may be generated by an user, a recoil unit capable of storing energy supplied by the user through one of the movements and releasing the energy through the other of the movements, an actuator member, and the like. The system may include at least one viscous unit and/or at least one elastic unit to manipulate at least one of the movements of the cover member. Such energy may be sufficient for one of the movements or may only correspond to a portion of energy required therefor.

The system may include at least one sensor member for sensing positions and/or movements of the cover member and may control the timings of the movements of the cover member between the states based thereupon. The sensor member may have at least one of multiple sensors, where one sensor may sense at least one of the positions of the door, another sensor may sense a timing of at least one of the movements of the cover member, another sensor may sense a duration of the cover member in at least one of the positions, another sensor may sense a duration of the door in at least one of the positions, and the like.

In another aspect of the present invention, a method may also be provided for covering at least a portion of a gap which may be formed between a coupling end of a frame and a rear end of a door, where such gap may be defined closer to a rotating axis of the door when the door may move away from its closed position.

In one exemplary embodiment of this aspect of the present invention, a method may include the steps of: installing at least one cover member adjacent to at least one of the ends; and forming the gap by moving the door away from the closed position. In one example, the method may include the step of moving at least a portion of the cover member across (or over) the portion of gap, thereby covering (or isolating, blocking access to) at least a portion of the gap. In another example, such a method may include the step of extending at least a portion of the cover member across (or over) the portion of the gap, thereby covering (or isolating, blocking access to) at least a portion of such gap. In yet another example, the method may include the step of filling the portion of the gap with at least a portion of the cover member, thereby covering (or isolating, blocking access to) at least a portion of the gap.

In another exemplary embodiment of this aspect of the present invention, a method may include the steps of: operatively coupling at least one cover member with such a door; and forming the gap by moving the door away from the closed position. In one example, the method may include the steps of: disposing at least a portion of the cover member across (or over, inside) the gap thereafter; returning the door to the closed position; and then restoring the portion of the cover member to its original state based upon a second preset temporal relation with the returning. In another example, the method may also include the steps of: disposing at least a portion of the cover member across (or over, inside) the gap based on a first preset temporal relation with the above forming; returning the door to the closed position; and then restoring the portion of the cover member to its original state thereafter. In another example, the method may also include the steps of: disposing at least a portion of the cover member across (or over, inside) the gap thereafter according to a first preset temporal relation with the above forming; returning the door to the closed position; and restoring the portion of the cover member to its original state according to a second preset temporal relation with the returning.

In another exemplary embodiment of this aspect of the present invention, a method may include the steps of: operatively coupling at least one cover member with such a door; and forming the gap by moving the door away from the closed position along an opening path. In one example, such a method may include the steps of: disposing at least a portion of the cover member across (or over, inside) the gap along a covering path which may be in a first preset spatial relation with the above opening path; returning the door toward the closed position in a closing path; and restoring the portion of the cover member toward its original state along an uncovering path thereafter. In another example, the method may include the steps of: disposing at least a portion of the cover member across (or over, inside) the gap thereafter; returning the door to the closed position along a closing path; and restoring the portion of the cover member toward its original state in an uncovering path which may be in a second preset spatial relation with the closing path. In another example, the method may further include the steps of: disposing at least a portion of the cover member across (or over, inside) such gap thereafter along a covering path which may be in a first preset spatial relation with the opening path; returning the door to the closed position along a closing path; and then restoring the portion of the cover member toward its original state along an uncovering path which may be in a second preset spatial relation with such a closing path.

In another exemplary embodiment of this aspect of the present invention, a method may include the steps of: operatively coupling at least one cover member to the door; applying force onto the door, thereby moving the door away from the closed position while forming the above gap; storing at least a portion of the force; and applying such a portion of the force to at least a portion of the cover member, thereby moving the portion thereof across (or over, inside) such gap and covering at least a portion of the gap.

In another exemplary embodiment of this aspect of the present invention, a method may include the steps of: mechanically coupling at least one cover member to the door; applying force to the door, thereby moving the door away from the closed position and forming the gap; storing at least a portion of the force; and applying the portion of the force onto at least a portion of the cover member, thereby disposing such a portion of the cover member across (or over, inside) the gap and covering at least a portion of the gap.

In another exemplary embodiment of this aspect of the present invention, a method may include the steps of: installing at least one cover member near at least one of the ends; disposing at least one sensor for detecting movement of the door; forming the gap by moving the door away from the closed position; detecting the above moving by the sensor; and moving at least a portion of the cover member across (or over, inside) the gap in response to such detecting, thereby covering at least a portion of the gap.

In another aspect of the present invention, a method may also be provided for covering at least a portion of a gap with at least one cover member, where the gap may be formed between a coupling end of a frame and a rear end of a matching door, defined closer to a rotating axis of the door when the door may move away from its closed position.

In one exemplary embodiment of this aspect of the present invention, a method may include the steps of: installing at least one cover member near at least one of the ends; forming the gap by moving the door away from the closed position; and disposing at least a portion of the cover member across (or over, inside) the portion of the gap thereafter, thereby covering at least a portion of the gap.

In another exemplary embodiment of this aspect of the present invention, a method may include the steps of: installing at least one cover member adjacent to at least one of the ends; folding at least a portion of the cover member when the door may be in the closed position; and unfolding the portion of the cover member, thereby covering such a portion of the gap by the portion of the cover member when the door moves away from the closed position and form the gap.

In another exemplary embodiment of this aspect of the present invention, a method may include the steps of: installing at least one cover member adjacent to at least one of the ends; rolling at least a portion of the cover member around a roller when the door may be in the closed position; and unrolling the portion of the cover member from the roller, thereby covering at least a portion of the gap by such a portion of the cover member when the door may move away from the closed position and form the gap.

In another exemplary embodiment of this aspect of the present invention, a method may include the steps of: installing at least one cover member close to at least one of the ends; stacking at least a portion of the cover member over its another portion when the door may be in the closed position; and unstacking the portion of the cover member from the another portion, thereby covering the portion of the gap by the portion of the cover member when the door may move away from the closed position and form the gap.

In another exemplary embodiment of this aspect of the present invention, a method may include the steps of: installing at least one cover member close to at least one of the ends; disposing at least a portion of the cover member adjacent to at least one of the ends when the door may be in the closed position; and sliding, rotating, and/or pivoting the portion of the cover member, thereby covering such portion of the gap by the portion of the cover member when the door may move away from the closed position and form the gap.

In another exemplary embodiment of this aspect of the present invention, a method may include the steps of: installing at least one cover member close to at least one of the ends; maintaining at least a portion of the cover member in one shape or size when the door may be in the closed position; and then changing at least one configuration of the portion of the cover member to another shape or size, thereby covering the portion of the gap by the portion of the cover member when the door may move away from the closed position and form the gap.

In another exemplary embodiment of this aspect of the present invention, a method may include the steps of: installing at least one cover member close to at least one of the ends; disposing at least a portion of the cover member adjacent to at least one of the ends when the door may be in the closed position; moving the door away from the closed position; and moving the portion of the cover member across (or over, inside) the gap at a timing which may be in a preset temporal relation with the moving of the door, thereby covering at least a portion of the gap by the portion of the cover member when the door may move away from the closed position and form the gap.

In another exemplary embodiment of this aspect of the present invention, a method may include the steps of: installing at least one cover member close to at least one of the ends; disposing at least a portion of the cover member adjacent to at least one of the ends when the door may be in the closed position; moving the door away from the closed position along an opening path; and moving the portion of the cover member across (or over, inside) the gap along a covering path which may be in a preset spatial relation with the opening path of the door, thereby covering at least a portion of such gap with the portion of the cover member when the door may move away from the closed position and form the gap.

In another exemplary embodiment of this aspect of the present invention, a method may include the steps of: installing at least one cover member close to at least one of the ends; disposing at least a portion of the cover member adjacent to at least one of the ends when the door may be in the closed position; applying force to the door, thereby moving the door away from the closed position; and then moving the portion of the cover member across (or over, inside) the gap by utilizing at least a portion of the force, thereby covering at least a portion of the gap with the portion of the cover member when the door may move away from the closed position and form the gap.

In another aspect of the present invention, a door safety system for a door may be provided in which the door may be arranged to movably couple with a frame, to rotate between at least one open position and at least one closed position about a rotating axis defined with respect to such a frame, to define a rear end close to the rotating axis and a front end opposite to the rear end, and to form a gap between the frame and rear end of the door as the door moves away from the closed position.

In one exemplary embodiment of such an aspect of this invention, a system may be made by a process including the steps of: operatively coupling at least one cover member with at least one of the frame and door; and arranging at least a portion of the cover member to be disposed adjacent to such a frame and/or door when the door may be in the closed position. In one example, such a method may include the step of arranging the portion of the cover member to at least partially extend across such a rear end of the door and frame when the door may move away from the closed position. In another example, the method may also include the step of arranging the portion of the member to cover at least a portion of the gap when the door may move away from the closed position. In another example, the method may include the step of arranging the portion of the member to isolate at least a portion of the gap when the door may move away from the closed position. In another example, such a method may include the step of arranging the portion of the cover member to fill at least a portion of the gap when the door may move away from the closed position. In another example, the method may also include the step of arranging the portion of the cover member to block access to at least a portion of the gap when the door moves away therefrom.

In another exemplary embodiment of such an aspect of the present invention, a system may be made by a process including the steps of: operatively coupling at least one cover member with such a frame and/or door; and providing at least one cover member. In one example, the method may include the step of arranging at least a portion of the cover member to be folded when the door may be in the closed position and to be unfolded when the door may move away from the closed position, thereby covering (or isolating, filling, extending across, blocking access to) at least a portion of the gap by the unfolded portion thereof. In another example, the method may include the step of arranging at least a portion of the cover member to remain rolled when the door may be in the closed position and then to be unrolled when the door may move away from the closed position, thereby covering (or extending across, isolating, filling, blocking access to) at least a portion of the gap by the above unrolled portion. In another example, the method may have the step of arranging at least a portion of the cover member to be stacked when the door may be in the closed position, and to be unstacked when the door may move away from the closed position, thereby covering (or isolating, filling, extending across, blocking access to) at least a portion of the gap by the unstacked portion thereof. In another example, such a method may include the step of arranging at least a portion of the cover member to be disposed close to the frame and/or door when the door may be in the closed position and to pivot, rotate, and/or slide with the door when the door may move away from the closed position, thereby covering (or isolating, filling, extending across, blocking access to) at least a portion of the gap by at least one of the portion of the cover member. In another example, the method may also include the step of arranging at least a portion of the cover member to form a smaller shape (or size) between the door and frame when the door may be in the closed position, and to deform while changing its configuration into a bigger shape (or size) when such a door may move away from the closed position, thereby covering (or extending across, isolating, filling, blocking access to) at least a portion of the gap by the deformed portion.

In another exemplary embodiment of such an aspect of the present invention, a system may be made by a process including the steps of: operatively coupling at least one cover member to the frame and/or door; providing at least one cover member capable of operating between at least one off-state and at least one on-state based on a preset temporal relation with the door which moves between the closed and open position; arranging at least a portion of the cover member to be disposed adjacent to the frame and/or door in the off-state; and arranging the portion of the cover member to cover (or fill, extend across, block access to, isolate) at least a portion of the gap in the on-state, while arranging the preset relation to at least partially control timings of operations of the cover member between such states as well as timings of movements of the door between such positions.

In another exemplary embodiment of such an aspect of the present invention, a system may be made by a process including the steps of: operatively coupling at least one cover member to the frame and/or door; providing at least one cover member capable of operating between at least one off-state and at least one on-state based on a preset spatial relation with the door moving between the closed and open position; arranging at least a portion of the cover member to be disposed close to the frame and/or door in the off-state; and arranging such a portion of the cover member to cover (or fill, extend across, block access to, isolate) at least a portion of the gap in such an on-state, while arranging the preset relation to at least partially determine paths of the cover member between the states and paths of the door between the positions.

In another exemplary embodiment of such an aspect of the present invention, a system may be made by a process including the steps of: providing at least one cover member capable of operating between at least one off-state and at least one on-state; operatively coupling the cover member with the frame and/or door; and arranging the cover member to move from one to the other of the off- and on-states by a force driving the door to move from one to the other of the open and closed positions while arranging at least a portion of the cover member to cover (or isolate, extend across, fill, block access to) at least a portion of the gap in the on-state.

In another exemplary embodiment of such an aspect of the present invention, a system may be made by a process including the step of operatively coupling at least one cover member with the door and/or frame. In one example, the method may include the steps of: arranging at least a portion of the cover member to be hidden between the rear end of the door and frame when the door may be in the closed position; and further arranging the portion of the cover member to be exposed while covering (or filling, isolating, extending across, blocking access to) at least a portion of the gap when the door may move away from the closed position. In another example, the method may include the steps of: arranging at least a portion of the cover member to be disposed out of the frame and rear end of the door when the door may be in the closed position; and arranging the portion of the cover member to change its configuration while covering (or isolating, filling, extending across, blocking access to) at least a portion of the gap when the door may move away from the closed position.

In another exemplary embodiment of such an aspect of the present invention, a system may be made by a process having the steps of: coupling at least one cover member with the door; disposing at least a portion of the cover member adjacent to the frame and/or door when the door may be in the closed position; and arranging the portion of the cover member to cover (or fill, extend across, block access to, isolate) at least a portion of the above gap when the door may move away from the closed position while maintaining the coupling. In a related embodiment, a process may include the steps of: coupling at least one cover member with the frame; disposing at least a portion of the cover member close to the frame and/or door when the door may be in the closed position; and arranging the portion of the cover member to cover (or fill, extend across, block access to, isolate) at least a portion of the gap when the door may move away therefrom while maintaining the coupling. In yet another related embodiment, a process may include the steps of: coupling at least one cover member with each of the door and frame; disposing at least a portion of the cover member close to the frame and/or door when the door may be in the closed position; and arranging the portion of the cover member to cover (or fill, extend across, block access to, isolate) at least a portion of the gap when the door may move away therefrom while maintaining the coupling.

In another aspect of the present invention, a door assembly may be provided for coupling with a matching frame and capable of moving between at least one closed position and at least one open position about a rotating axis which may be defined on (or near) the frame.

In one exemplary embodiment of such an aspect of this invention, an assembly may be made by a process including the steps of: providing a rear end and a front end to a door; arranging the rear end to be disposed close to the rotating axis; arranging the front end to be disposed opposite to such a rear end; arranging the rear end to form a gap with respect to the frame when the door may couple with the frame and move away from the closed position; and providing at least one cover member in the rear end. In one example, the process may also include the step of arranging at least a portion of the cover member to cover (or isolate, extend across, block access to, fill) at least a portion of such gap when the door may be coupled to the frame and move away from the closed position. In another example, the process may also include the step of arranging at least a portion of the cover member to remain folded when the door may be coupled to the frame and disposed in the closed position, and to be unfolded when the door may move away from the closed position, thereby covering (or isolating, extending across, filling, blocking access to) at least a portion of the gap. In another example, such a process may include the step of arranging at least a portion of the cover member to be stacked over another portion thereof when the door may couple with the frame and disposed in the closed position, and to be unstacked away from the another portion when the door may move away from the closed position, thereby covering (or isolating, blocking access to, filling, extending across) at least a portion of the gap. In yet another example, the process may include the steps of: providing the cover member with a roller; and arranging at least a portion of the cover member to be rolled around the roller when the door may be coupled to the frame and disposed in the closed position, and to be rolled out of such a roller when the door may move away from the closed position, thereby covering (or isolating, filling, blocking access to, extending across) at least a portion of the gap. In another example, the process may include the step of arranging at least a portion of the cover member to be disposed close to the door and frame when the door may be coupled to the frame and disposed in the closed position, and to slide across (or over) at least a portion of the gap when the door may move away from the closed position, thereby covering (or filling, isolating, extending across, blocking access to) at least a portion of the gap. In another example, the process may include the step of arranging at least a portion of the cover member to form a smaller shape (or size) between the rear end and frame when the door may be coupled to the frame and disposed in the closed position, and then to deform while changing such configuration to a bigger shape (or size) when such a door may move away from the closed position, thereby covering (or isolating, extending across, blocking access to, filling) at least a portion of such gap.

In another exemplary embodiment of this aspect of the present invention, an assembly may be made by a process including the steps of: providing a door which includes a rear end and a front end; arranging the rear end to be disposed adjacent to the rotating axis; arranging the front end disposed opposite to the rear end; arranging such a rear end to form a gap with respect to the frame when the door may be coupled to the frame and move away from the closed position; incorporating a housing into the door; providing at least one cover member in such a rear end of the door; arranging at least a portion of the cover member to be disposed in the housing when the door may couple with the frame and may be disposed in the closed position; and arranging the portion of the cover member to move out from the housing so as to cover (or isolate, extend across, fill, block access to) at least a portion of the gap when the door may move away from the closed position.

In another aspect of the present invention, a frame assembly may be provided to couple with a matching door, where the door may be arranged to move between at least one closed position and at least one open position about a rotating axis defined on (or near) the frame and to have a rear end for being disposed close to the rotating axis and a front end disposed opposite to the rear end and which may be capable of forming a gap between the rear end and frame when the door may couple with the frame and move away from the closed position.

In one exemplary embodiment of such an aspect of this invention, an assembly may be made by a process including the steps of: providing a frame; forming an opening into which the door may be movably disposed; incorporating at least one cover member to the frame; and then arranging at least a portion of the cover member to cover (or isolate, extend across, block access to, fill) at least a portion of the gap when the door may be coupled to the frame and move away from the closed position.

In another exemplary embodiment of this aspect of the present invention, an assembly may be made by a process including the steps of: providing a frame; forming an opening into which the door may be movably disposed; defining in the frame a coupling end which may be arranged to abut such a rear end of the door when the door may be coupled to the frame; and incorporating at least one cover member into the frame. In one example, the process may have the step of arranging at least a portion of the cover member to remain folded when the door may be coupled to the frame and disposed in the closed position, and to be unfolded when the door may move away from the closed position, thereby covering (or isolating, extending across, filling, blocking access to) at least a portion of the gap. In yet another example, the process may have the step of arranging at least a portion of the cover member to be stacked over another portion thereof when the door may be coupled to the frame and disposed in the closed position, and to be unstacked away from such another portion when the door may move away from the closed position, thereby covering (or extending across, isolating, blocking access to, filling) at least a portion of the gap. In another example, the process may instead include the steps of: providing the cover member with a roller; and arranging at least a portion of the cover member to be rolled around the roller when the door may be coupled to the frame and placed in the closed position, and to be rolled out of such a roller when the door may move away from the closed position, thereby covering (or isolating, blocking access to, extending across, filling) at least a portion of the gap. In yet another example, the process may have the step of arranging at least a portion of the cover member to be disposed close to the door and/or frame when the door may couple with the frame and may be disposed in the closed position, and to slide across (or over) at least a portion of such gap when the door may move away from the closed position, thereby covering (or filling, isolating, extending across, blocking access to) the portion of the gap. In another example, the process may include the step of arranging at least a portion of the cover member to define a smaller shape (or size) between the rear end of the door and coupling end of the frame when the door may couple with the frame and may be disposed in the closed position, and to deform while changing the configuration into a bigger shape (or size) when the door may move away from the closed position, thereby covering (or blocking access to, isolating, extending across, filling) at least a portion of the gap.

In another exemplary embodiment of this aspect of the present invention, an assembly may be made by a process including the steps of: providing a frame; forming an opening into which the door may be movably disposed; defining in the frame a coupling end which may be arranged to abut such a rear end of the door when the door may be coupled to the frame; incorporating a housing to the door; providing at least one cover member in the coupling end of the frame; arranging at least a portion of the cover member to be disposed in the housing when the door may couple with the frame and may be disposed in the closed position; and arranging the portion of the cover member to move out from the housing in order to cover (or isolate, extend across, fill, block access to) at least a portion of the gap when the door moves away from the closed position.

Embodiments of the above method and/or process aspects of the present invention may also include one or more of the features which may be similar to or identical to those of the system and/or assembly aspects of this invention.

More product-by-process claims may be constructed by modifying the foregoing preambles of the systems or assemblies claims and by appending thereto the above bodies of the method claims. In addition, such process claims may further include one or more of the above features of the apparatus and method claims of the present invention.

As used herein, the term “gap” refers to a preset space defined between a rear end of a door and a coupling end of a matching frame which is to be covered by at least one cover member of such a door safety system of the present invention. Because such a door is designed to move between its closed position and open position, the “gap” generally changes its shape and size as the door rotates or otherwise moves between such positions, while attaining its maximum size when the door reaches its fully open position and reduced to its minimum size when the door reaches its fully closed position. The definition of such a “gap” generally depends upon various factors such as, e.g., orientation of the door with respect to a matching frame for the door, movements of the door with respect to the frame, directions and/or paths of the movements of the door, and so on. For example, when the door pivots or rotates about a rotation axis (such as a hinge) to open and close, the “gap” may form a shape of a vertical truncation of a cylinder with a round cross-section. When the door opens and closes laterally (either linearly or arcuately), the “gap” may have a shape of a slab. It is appreciated that such a “gap” may also encompass any space in and around the rear end of the door and coupling end of the frame as long as such a space may catch and inflict physical damage on a body part of an user when such a door moves to its closed position.

As used herein, the terms “on-state” and “off-state” are used for various door safety systems and/or their cover members and covers. Accordingly, a cover member and its cover may be referred to be disposed in the “on-state” when the cover member and its cover may be disposed in a state for covering, filling, blocking access to, and/or isolating at least a portion of such a gap. Similarly, a cover member and its cover may be referred to be disposed in the “off-state” when the cover member or its cover may be disposed in another state for not having to cover, fill, block access to, and/or isolate the portion of the gap. The “on-state” and “off-state” may be used for other members and/or parts of the door safety system as well. For example, a recoil unit, a guide, a support, and a coupler of the cover member and/or door safety system may similarly be referred to operate between their “on-states” and “off-states,” where such states may correspond to the position of the recoil unit, guide, support, and coupler as the door safety system, cover member, and/or cover may be in their “on-states” and “off-states,” respectively.

Unless otherwise defined in the following specification, all technical and scientific terms used herein have the same meaning as commonly understood by one of ordinary skill in the art to which the present invention belongs. Although the methods or materials equivalent or similar to those described herein can be used in the practice or in the testing of the present invention, the suitable methods and materials are described below. All publications, patent applications, patents, and/or other references mentioned herein are incorporated by reference in their entirety. In case of any conflict, the present specification, including definitions, will control. In addition, the materials, methods, and examples are illustrative only and not intended to be limiting.

Other features and advantages of the present invention will be apparent from the following detailed description, and from the claims.

### BRIEF DESCRIPTION OF THE DRAWING

FIGS. 1A and 1B are perspective views of a conventional door (prior art) which are disposed respectively in its closed position and in its open position;

FIGS. 2A and 2B are perspective views an exemplary door safety system which incorporates a rollable cover operating in its off- and on-state respectively according to the present invention;

FIGS. 2C and 2D are perspective views another exemplary door safety system which includes stackable covers operating in their off- and on-state respectively according to the present invention;

FIGS. 2E and 2F are perspective views another exemplary door safety system which includes a deformable cover operating in its off- and on-state respectively according to the present invention;

FIGS. 2G and 2H are perspective views another exemplary door safety system which includes a slidable cover operating in its off- and on-state respectively according to the present invention;

FIGS. 3A to 3D are perspective views of various foldable cover members including at least one foldable cover according to the present invention;

FIGS. 3E to 3G are perspective views of various foldable cover members of FIGS. 3A to 3D in their on-states according to the present invention;

FIGS. 4A to 4D are perspective views of various stackable cover members having at least one stackable cover according to the present invention;

FIGS. 4E to 4G are perspective views of various stackable cover members of FIGS. 4A to 4D in their on-states according to the present invention;

FIGS. 5A to 5C are perspective views of various rollable cover members including at least one rollable cover according to the present invention;

FIGS. 5D to 5F are perspective views of various rollable cover members of FIGS. 5A to 5C in their on-states according to the present invention;

FIGS. 6A to 6D are perspective views of various slidable cover members including at least one slidable cover according to the present invention;

FIGS. 6E to 6G are perspective views of various slidable cover members of FIGS. 6A to 6D in their on-states according to the present invention;

FIGS. 7A to 7X are perspective views of various deformable cover members including at least one deformable cover according to the present invention;

FIG. 8 is a series of schematic diagrams for exemplary temporal relations or synchronization between movements of exemplary cover members and doors according to the present invention; and

FIGS. 9A to 9C show perspective views of exemplary recoil units for complementary relations between movements of exemplary cover members and doors according to the present invention.

### DETAILED DESCRIPTION OF THE PREFERRED EMBODIMENTS

The present invention generally relates to door safety systems incorporated into a gap formed between a rear end of a door and a matching frame and covering the gap while the door is open such that an user may protect his or her fingers or toes from being caught in the gap when the door may be shut unexpectedly. More particularly, the present invention relates to various covers of such systems which may translate, rotate, and/or pivot across (or over) and cover at least a portion of the gap, may fill or occupy such a portion of the gap and block access to the gap, or may otherwise isolate such a portion of the gap when the door is or kept open. As will be described in detail below, the door safety systems of the present invention may be practiced through numerous embodiments each including at least one movable or deformable cover which may cover the portion of the gap in temporal, spatial or complementary relation to opening and closing movements of the door and/or presence or absence of an object inside the gap. This invention also relates to various door or frame assemblies incorporating such door safety systems therein and door-frame assemblies incorporating therein such door safety systems. The present invention also relates to various methods of providing such deformable and/or movable covers, various methods of incorporating such covers into the door, frame, and door-frame assemblies, and various methods of covering such a portion of the gap by such covers. The present invention further relates to various processes for fabricating such movable and/or deformable covers, door assemblies, frame assemblies, and door-frame assemblies.

Various door safety systems of the present invention offer numerous benefits. For example, such systems may protect an user from physical injuries in case his or her fingers or toes should be caught in the gap and crushed by the door when the door is unexpectedly shut to close. By covering the gap, filling the gap or otherwise blocking access to the gap, the door safety systems may make it practically impossible for the user to place his or her body parts inside such a gap, thereby preventing such physical injuries. Such door safety systems may be shaped and/or sized to be incorporated into the gap so that at least substantial portions thereof may be hidden between the door and frame when the door is closed. Alternatively, such systems may be shaped and/or sized to be disposed outside the door and/or frame so that their covers may always cover, block access to, and/or isolate the gap regardless of whether the door is open or closed. The door safety systems may be incorporated to the door assemblies, frame assemblies or door-frame assemblies in a factory so that all the user has to do is to install such assemblies. In the alternative, such door safety systems may be provided to be retrofit into existing doors and/or frames as well.

Various door safety systems of this invention may be readily applied to conventional revolving or rotating doors of structures such as houses, buildings, and so on, so as to cover, fill, block access to, and/or isolate at least a portion of the gap. When desired, the door safety systems may be applied to conventional sliding doors and cover, fill, block access to, and/or isolate at least a portion of the gap as well, where such a gap is formed as such doors laterally move away from their closed positions. Various door safety systems of this invention may also be applied to other conventional doors as long as such doors may form the gap as they may move from their closed positions to their open positions. For example, such systems may be implemented to doors of vehicles including automobiles, airplanes, surface vessels, and so on. Such systems may also be incorporated into doors of other conventional articles such as cabinets, brief cases, luggage bags, boxes, and so on. In short, various door safety systems of this invention may be implemented to various articles which may open and close and may form the gap during such opening and/or closing movements.

Various aspects and/or embodiments of various systems, methods, and/or processes of this invention will now be described more particularly with reference to the accompanying drawings and text, where such aspects and/or embodiments thereof only represent different forms. Such systems, methods, and/or processes of this invention, however, may also be embodied in many other different forms and, accordingly, should not be limited to such aspects and/or embodiments which are set forth herein. Rather, various exemplary aspects and/or embodiments described herein are provided so that this disclosure will be thorough and complete, and fully convey the scope of the present invention to one of ordinary skill in the relevant art.

Unless otherwise specified, it is to be understood that various members, units, elements, and parts of various systems of the present invention are not typically drawn to scales and/or proportions for ease of illustration. It is also to be understood that such members, units, elements, and/or parts of various systems of this invention designated by the same numerals may typically represent the same, similar, and/or functionally equivalent members, units, elements, and/or parts thereof, respectively.

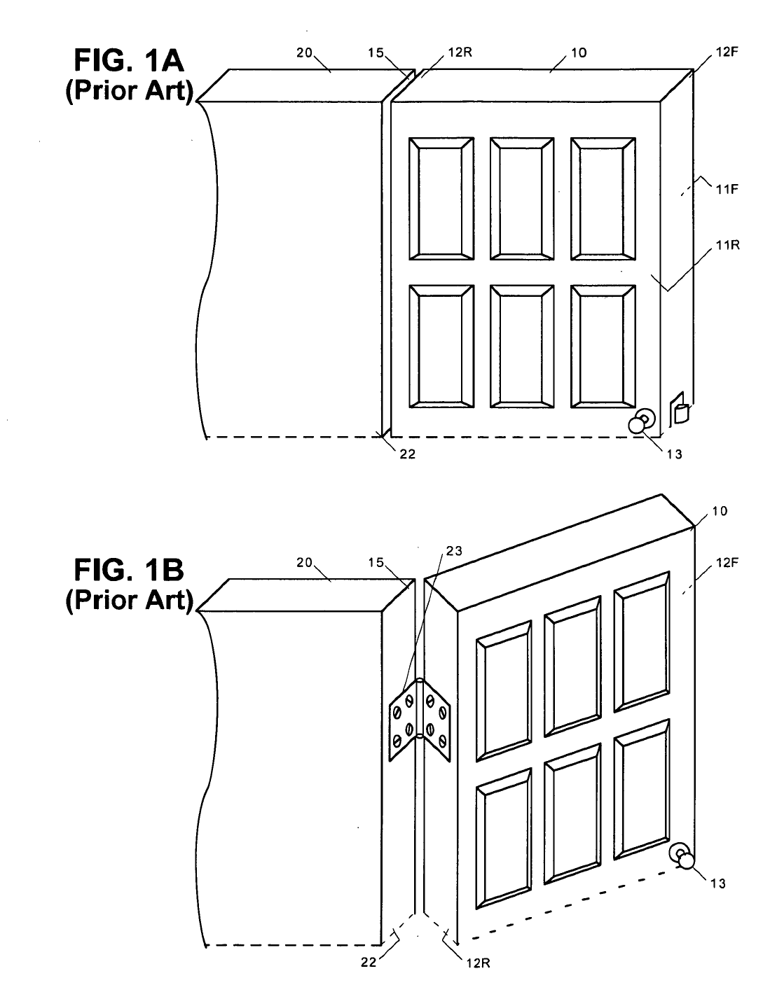

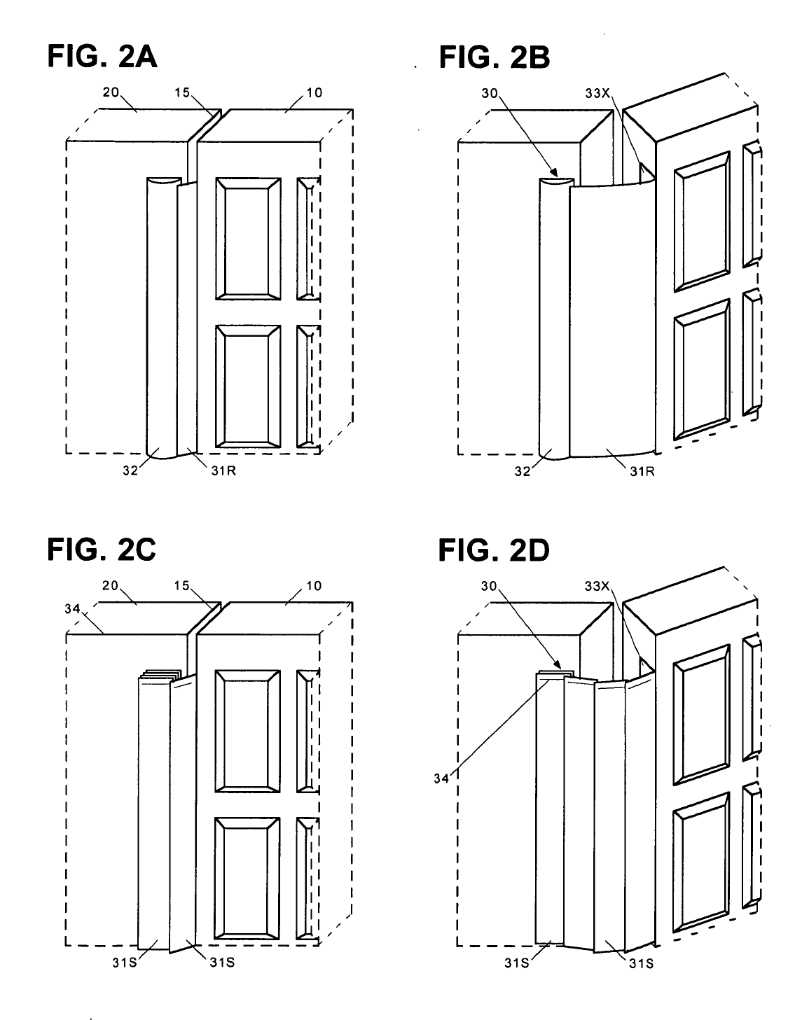

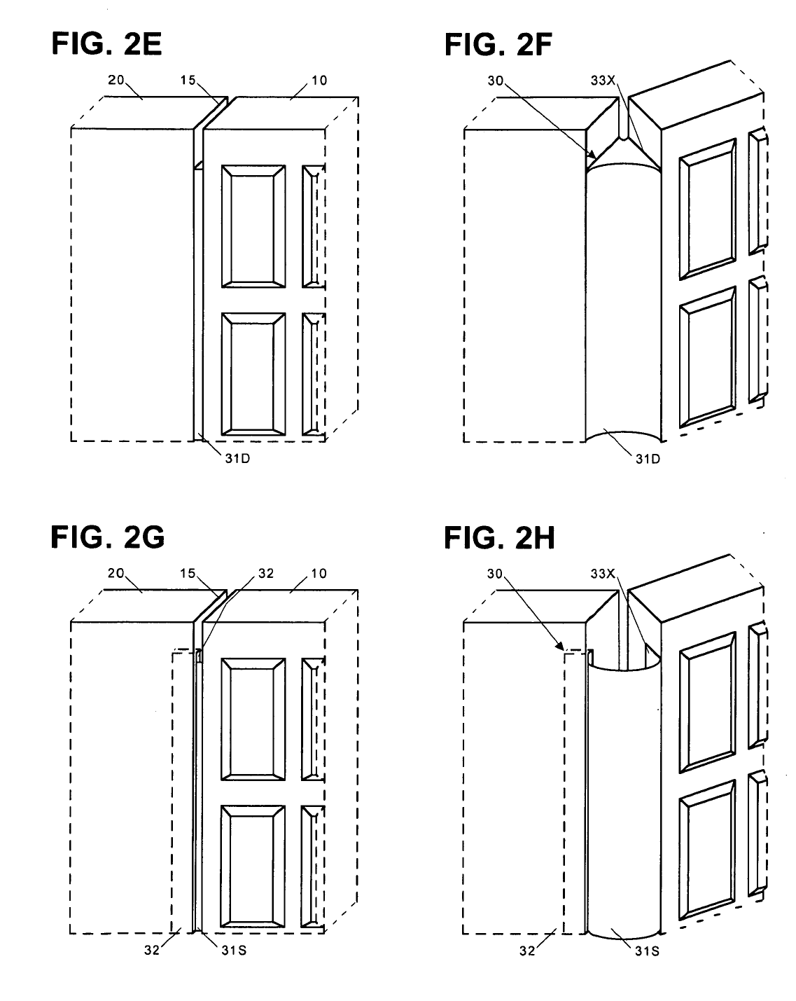

FIGS. 2A through 2H depict several exemplary door safety systems of the present invention, where such door safety systems may incorporate different covers which may have different shapes, may operate according to different mechanisms, may expose different portions thereof, and the like. It is appreciated that doors and frames of these figures have the same configurations as those of FIGS. 1A and 1B and, thus, various parts of such doors and frames will be denoted by the same numerals.

In one aspect of the present invention, a rollable cover may be used to cover at least a portion of a gap as exemplified in FIGS. 2A and 2B which are perspective views of an exemplary door safety system which incorporates a rollable cover operating in its off- and on-state respectively according to the present invention. Such a system 30 includes a rollable cover 31R and a housing 32, where such a housing 32 is generally disposed on or beside a coupling end of a frame 20. The rollable cover 31R is arranged to be rolled onto and out of a roller (not shown in the figures) which is disposed inside the housing 32. One end 33X of the cover 31R is also fixedly coupled to the rear end 12R. Therefore, as the door 10 opens away from its closed position (see FIG. 2A) toward its open position (see FIG. 2B), the fixed end 33X of the cover 31R rotates away from the housing 32 along with the door 10 toward its on-state, thereby pulling out another portion of the cover 31R out of the roller and covering at least a portion of the gap 15. Thereafter, as the door 10 begins to close toward its closed position, a recoil unit (not shown in the figure) which may be disposed inside or outside of the housing 32 may pull the exposed portion of the cover 31R back into the housing 32 toward its off-state and roll such a portion of the cover 31R onto or around the roller, where details of the recoil unit will be provided below.

In another aspect of the present invention, a stackable cover may be used to cover at least a portion of a gap as exemplified in FIGS. 2C and 2D which are perspective views of another exemplary door safety system which includes stackable covers operating in their off- and on-state respectively according to the present invention. Such a system 30 includes multiple stackable covers 31S each of which is movably or releasably coupled to each other by at least one coupler. Such stackable covers 31S are also arranged to form a stack by being disposed one over the other and then to be unstacked therefrom when pulled away by force. In addition, one end 33X of the stack is fixedly coupled to the rear end 12R of the door 10. Therefore, when the door 10 opens away from its closed position (see FIG. 2C) toward its open position (see FIG. 2D), the fixed end 33X of the stackable covers 31S moves with the door 10 by being pulled away from the stack toward its on-state, thereby pulling other covers 31S away from the stack and covering at least a portion of the gap 15. Thereafter, when the door 10 begins to close toward its closed position, the coupler 34 and/or an optional recoil unit (not shown in the figure) may pull the unstacked covers 31S back onto the stack toward its off-state.

In another aspect of the present invention, a deformable cover may be used to cover at least a portion of a gap as exemplified in FIG. 2E and 2F which are perspective views of another exemplary door safety system which includes a deformable cover operating in its off- and on-state respectively according to the present invention. Such a system 30 has at least one deformable cover 31D which is fixedly coupled to the rear end 12R of the door 10 and/or coupling end 22 of the frame 20. Such a deformable cover 31D is also arranged to undergo various configurational changes between its off- and on-states. In one embodiment, such a deformable cover 31D may have a stressed configuration in its off-state, e.g., by being compressed or squeezed between the rear end 12R and coupling end 22 of the frame 20. Therefore, when the door 10 opens away from its closed position (see FIG. 2E) toward its open position (see FIG. 2F), such a deformable cover 31D may relax and expand toward its unstressed configuration while filling at least a portion of the gap 15 toward its on-state. Thereafter, when the door 10 begins to close toward its closed position, the deformable cover 31D begins to be compressed or squeezed toward its stressed state and back to its off-state. It is appreciated in this embodiment that such a deformable cover 31D may need to couple with only one of the rear end 12R of the door 10 and coupling end 22 of the frame 20. In another embodiment, the deformable cover 31D may define the unstressed configuration in its off-state. Therefore, as the door 10 opens away from its closed position (see FIG. 2E) toward its open position (see FIG. 2F), such a deformable cover 31D may be stretched toward its stressed configuration while filling at least a portion of the gap 15 toward its on-state. Thereafter, when the door 10 begins to close toward its closed position, the deformable cover 31D begins to return toward its unstressed state and back to its off-state.

In another aspect of the present invention, a slidable cover may be applied to cover at least a portion of a gap as exemplified in FIGS. 2G and 2H which are perspective views of another exemplary door safety system including a slidable cover operating in its off- and on-state respectively according to the present invention. Such a system 30 has a slidable cover 31S and a housing 32, where such a housing 32 is typically disposed on or beside a coupling end 22 of a frame 20. Such a slidable cover 31S is arranged to slide into and out of the housing 32, while one end 33X of the cover 31S is fixedly coupled to the rear end 12R of the door 10. Accordingly, as the door 10 opens away from its closed position (see FIG. 2G) toward its open position (see FIG. 2H), the fixed end 33X of the slidable cover 31R moves with the door 10 toward its on-state, thereby pulling out another portion of the cover 31S out of the housing 32 and covering at least a portion of the gap 15. Thereafter, as the door 10 begins to close toward its closed position, a recoil unit (not shown in the figure) which may be disposed in or out of the housing 32 may pull the exposed portion of the cover 31S back into the housing 32 toward its off-state.

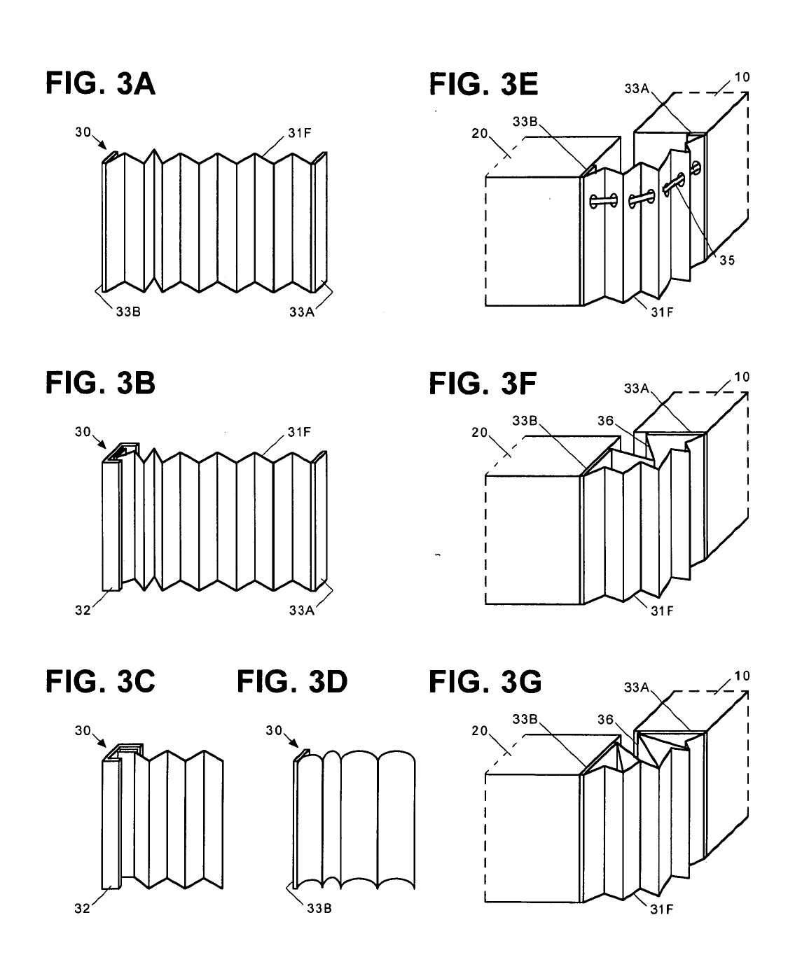

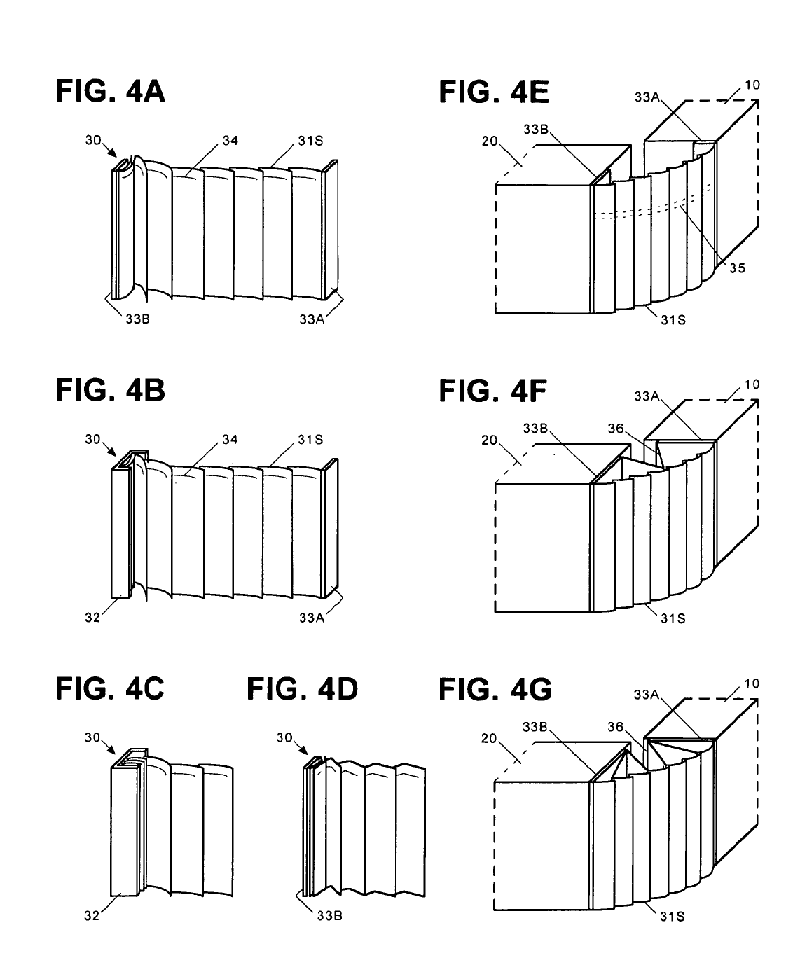

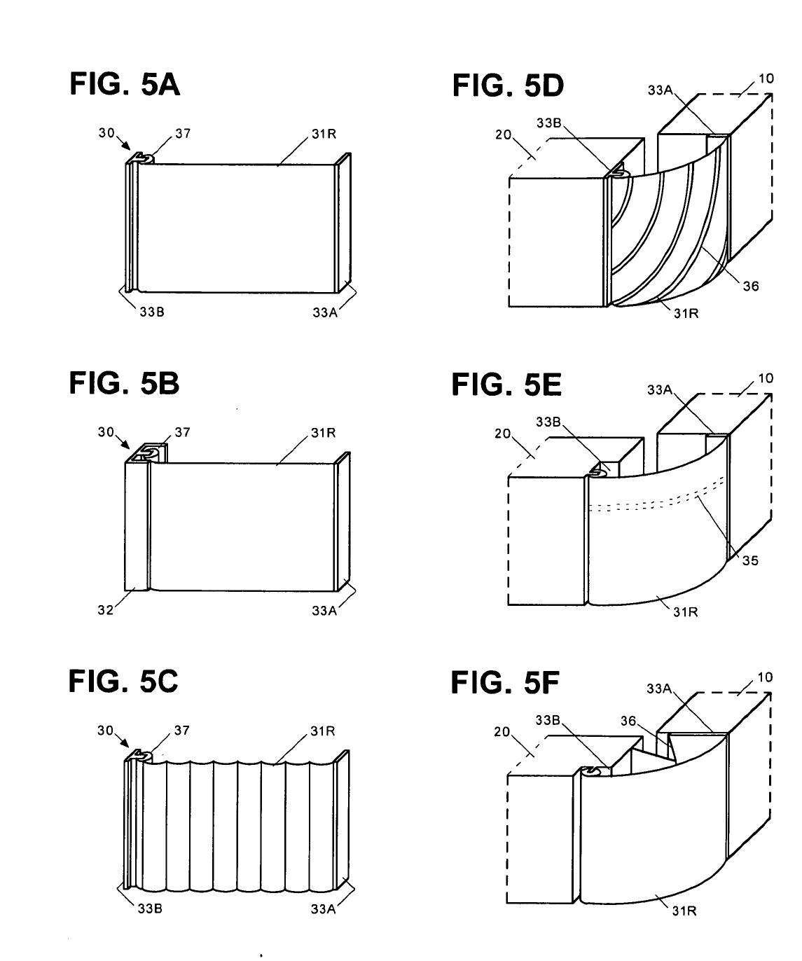

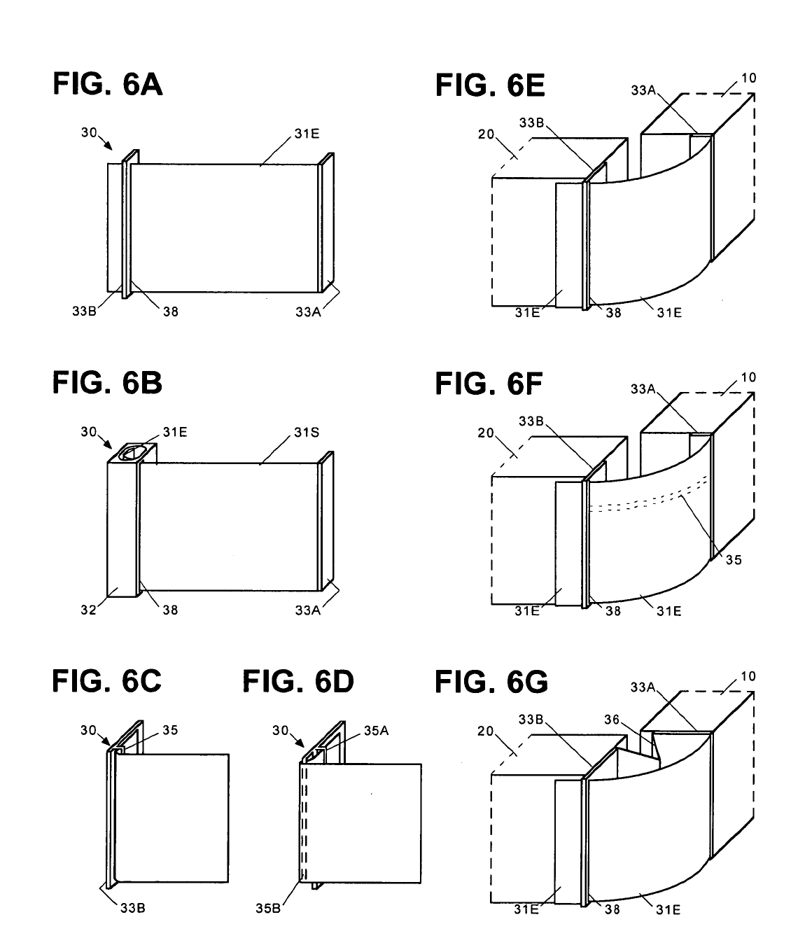

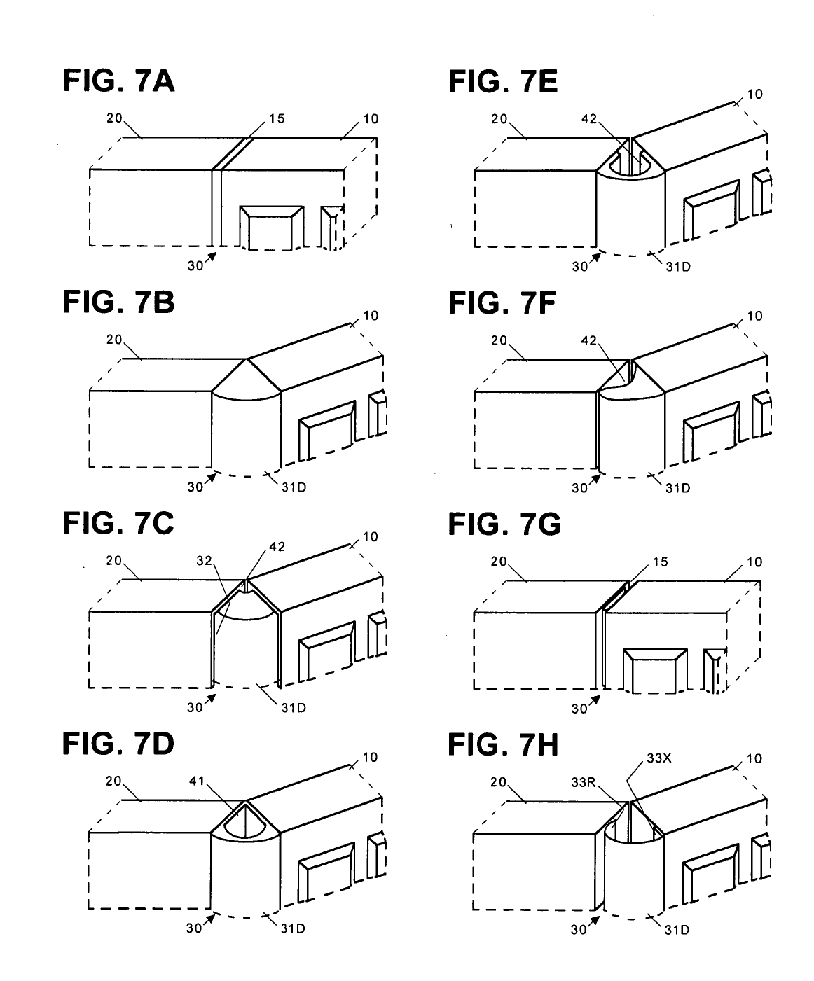

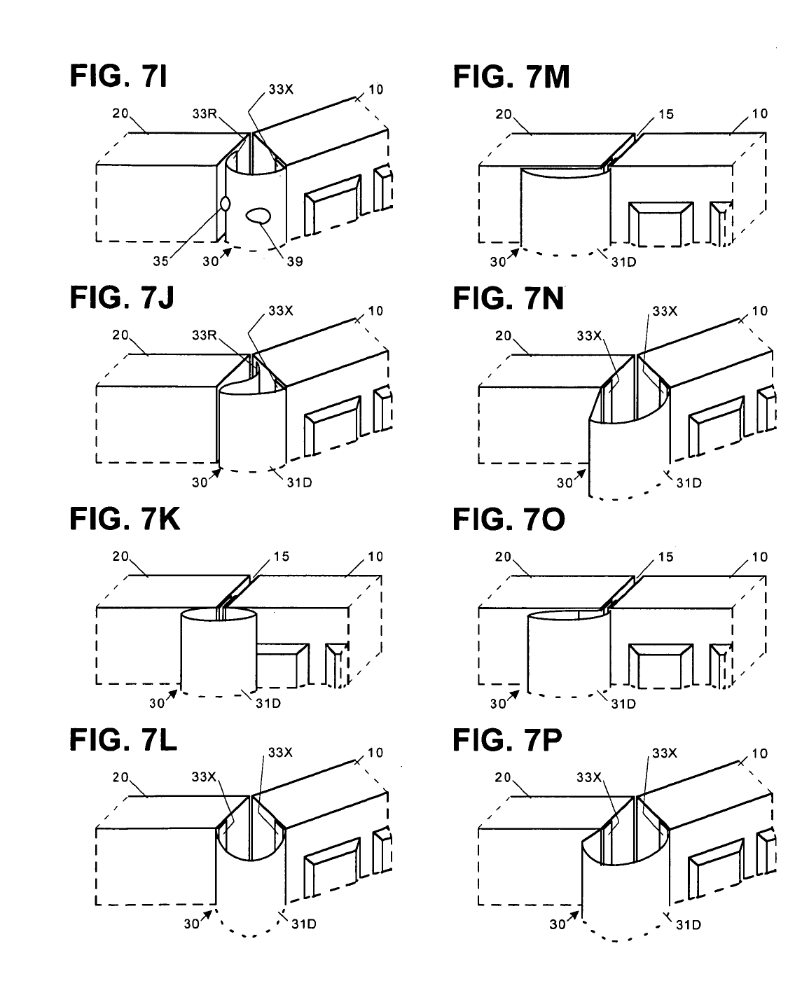

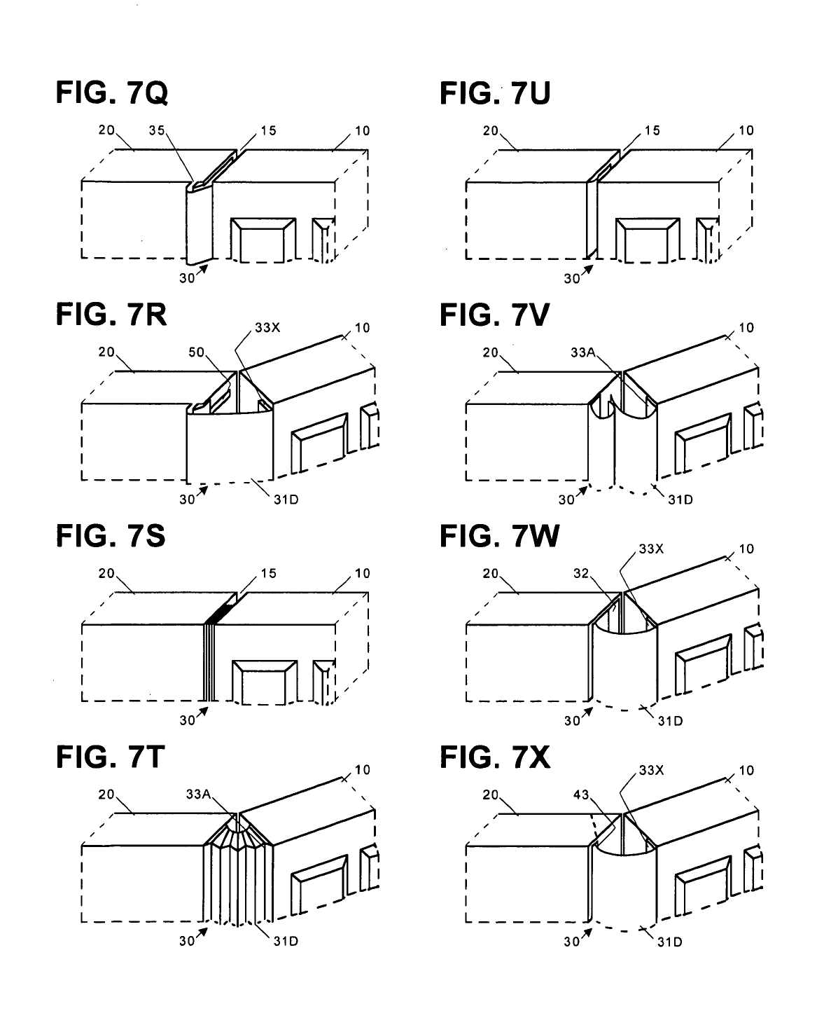

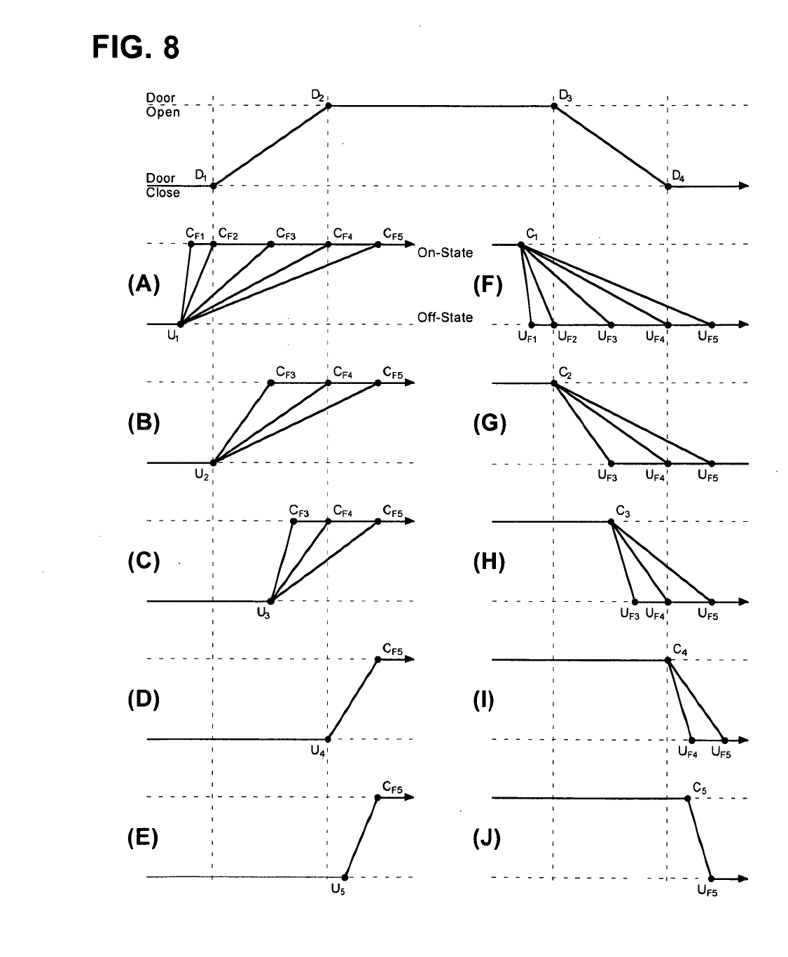

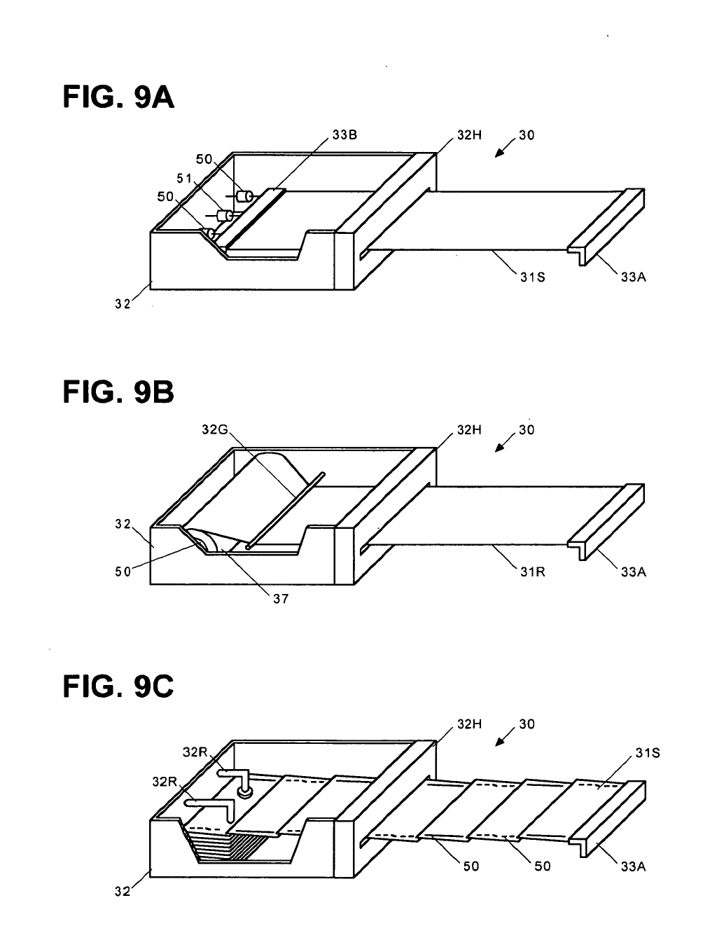

As briefly exemplified in FIGS. 2A through 2H, various cover members of the present invention are typically arranged to change at least one of their configurations such as their dimensions, shapes, and/or orientations during movements from their off-states to their on-states in order to cover at least a portion of the gap, where further examples of such configurations may include, but not be limited to, lengths, widths, heights, thicknesses or elevations, radii or diameters, angles, slopes, curvatures or contours, orientations and/or arrangements thereof and/or therebetween, overlaps thereover and/or therebetween, molecular or microscopic structure, a combination of the above, and the like. Details of such configurations of various cover members and their covers and related methods and processes therefor will now be described with reference to FIGS. 3 through 9. More particularly, FIGS. 3A to 3G describe various exemplary embodiments of foldable cover members and their covers, FIGS. 4A to 4G represent various exemplary embodiments of stackable cover members and their covers, FIGS. 5A to 5F describe various exemplary embodiments of rollable cover members and their covers, FIGS. 6A to 6G describe various exemplary embodiments of slidable cover members and their covers, while FIGS. 7A to 7X represent various exemplary embodiments of deformable cover members and their covers. In addition, FIG. 8 show various exemplary temporal relations between the cover members and doors, and FIGS. 9A to 9C describe various exemplary complementary relations between the cover members and recoil units according to the present invention.

Accordingly and in another aspect of the present invention, an exemplary cover member may include at least one foldable cover which may be arranged to be folded in its off-state and then to be unfolded and cover at least a portion of the gap in its on-state, where FIGS. 3A to 3D are perspective views of various foldable cover members including at least one foldable cover and where FIGS. 3E to 3G show perspective views of various foldable cover members of FIGS. 3A to 3D in their on-states according to the present invention.

In one exemplary embodiment and as shown in FIG. 3A, a door safety system 30 may have at least one foldable cover 31F which defines alternating top lines and bottom lines thereover and forms curvilinear polygonal sections therebetween. When the top and bottom lines are provided at an equal distance along its sides of the foldable cover 31F, each polygonal section may be arranged to have at least substantially rectangular shapes. The foldable cover 31F may be made of and/or include at least one material with at least minimal flexibility so that the cover 31F may be bent along the top and bottom lines. Other configurational and operational characteristics of such foldable covers 31F may be found in a co-pending application which is entitled “Door cover systems,” filed by the same Applicant on May 4, 2004, and bears a Ser. No. 10/838,009, an entire portion of which is to be incorporated herein by reference. The foldable cover 31F also defines a first end 33A and a second end 33B, where the former may couple with the rear end 12R of the door 10, while the latter may couple with the coupling end 22 of the frame 20. It is appreciated that, depending upon their coupling modes, either of the ends 33A, 33B may be referred to as the fixed end 33X as exemplified in FIGS. 2B, 2D, and 2H or as a free end 33R as will be described below.

In operation, the foldable cover 31F is kept in its (fully) off-state to its uncovering length when the door is in its closed position. When the door opens, the first end 33A may move with the door 10 but the second end 33B may be fixedly coupled to the frame 20. Accordingly, the foldable cover 31F may begin to unfold and increase its length while unfolding in a covering (or unfolding) direction along a covering (or unfolding) path which is generally traverse to the top and bottom lines of the cover 31F. As the door moves to its (fully) open position, the cover 31F may move to its (fully) on-state, attaining its covering length, and covering a preselected portion of the gap 15. As the door 10 begins to close, the foldable cover 31F may be pushed toward its off-state by the door 10 through its first end 33A or may be pulled toward its off-state by a recoil unit (not shown in the figure). Therefore, such a cover 31F may shorten its length in an uncovering (or folding) direction along an uncovering (or folding) path which may also be traverse to the top and bottom lines of the cover 31F. As the door 10 is completely shut to its (fully) closed position, the cover 31F may also be folded back to its fully off-state and back to its uncovering length, thereby allowing the cover 31F to uncover the preset portion of the gap 15.

In another exemplary embodiment and as shown in FIG. 3B, a door safety system 30 may have at least one foldable cover 31F which is generally similar to that of FIG. 3A. The system 30, however, includes a housing 32 which may be arranged to receive and retain at least a portion of the cover 31F when the door 10 is in its closed position and the cover 31F is in its off-state, where an amount of the portion of the cover 31F retainable inside the housing 32 may be determined by various factors such as, e.g., a depth or height of the housing 32, a thickness of the cover 31F, and so on. It is appreciated that such a housing 32 may be disposed in an orientation capable of receiving and releasing portions of the cover 31F in a direction parallel to the above folding and/or unfolding directions. The housing 32 may be disposed on the rear end 12R of the door 10, on a surface of the door 10, and the like. When desirable, the door 10 may define along the rear end 12R and/or surface at least one indentation into which at least a portion of the housing 32 may be embedded, where such an embodiment may offer a benefit of better protection against mechanical impacts onto the cover 31F, better appearance, and so on. In a related exemplary embodiment and as described in FIG. 3C, a system 30 may include a similar cover 31F and a similar housing 32, except that the latter may be oriented to receive and release such portions of the cover 31F in a direction which may be transverse or normal to the above folding and/or unfolding directions. Other configurational and/or operational characteristics of the systems of FIGS. 3B and 3C may be similar or identical to those of the system of FIG. 3A.

It is appreciated that such foldable covers may be arranged to have various shapes and sizes as long as they may be folded and unfolded while covering the preset portion of the gap. Accordingly and in another exemplary embodiment as described in FIG. 3D, such a system 30 may include a cover 31F which may be generally similar to that of FIG. 3A but define curved top and bottom lines such that the cover 31F may define curvilinear polygonal sections along its length. The foldable cover 31F may define other shapes and/or sizes as well, as described in the aforementioned co-pending application. Other configurational and/or operational characteristics of such a system of FIG. 3D may be similar or identical to those of the systems of FIGS. 3A to 3C.

Any of the above foldable covers may be incorporated between the rear end of the door and the coupling end of the frame. FIGS. 3E to 3G show several examples of the foldable covers in their on-states, where their first and second ends are respectively coupled to the rear and coupling ends. It is appreciated, however, that these figures only represent top portions of such covers, doors, and frames for simplicity of illustration.

In one exemplary embodiment and as shown in FIG. 3E, a guide 35 may be provided in order to provide mechanical integrity to the foldable cover 31F and/or to guide the cover 31F during movements between its off- and on-states. More particularly, the foldable cover 31F may form at least one hole in each of its polygonal segments, and the guide 35 may be releasably inserted or woven through such holes. It is to be understood that such a guide 35 may be arranged to extend and retract similar to an antenna or telescope. Therefore, such a cover 31F may be guided and/or supported by the guide 35 so as to maintain its configuration in its on-state in response to external force. Accordingly, when an user inadvertently pushes or presses the foldable cover 31F, such a cover 31F may resist the force, thereby continuing to cover the preset portion of the gap 15. Further configurational and operational characteristics of such a guide may be found in the aforementioned co-pending application.

In another exemplary embodiment and as depicted in FIG. 3F, a support 36 may be provided for providing mechanical support to the foldable cover 31F in its on-state. More specifically, the support 36 may include multiple surfaces, one of which may be coupled to the first end 33A of the cover 31F or the rear end 12R of the door, while another of which may be coupled to the second end 33B of the cover 31F or the coupling end 22 of the frame 20. Such a support 36 may include additional surfaces which may not be directly coupled to the cover 31F and may be arranged to fold and unfold along with the cover 31F between the off- and on-states, respectively. Accordingly, as the door 10 opens, one surface of the support 36 may move with the door 10 while unfolding and advancing other surfaces toward the cover 31F inside the gap 13. When the door moves to its (fully) open position, such middle surfaces of the support 36 may approach the cover 31F within a preset distance, thereby supporting the cover 31F against external force and preventing movement of the cover 31F toward the gap 15 in response to such force. As the door 10 begins to close, such middle surfaces of the support 36 may be folded to their off-state. As the door 10 is completely shut to its (fully) closed position, such middle surfaces of the support 36 may also be folded and disposed between the rear end 12R of the door 10 and the coupling end 22 of the frame 20, waiting for next opening movement of the door 10.

In another exemplary embodiment and as shown in FIG. 3G, a support 36 may be provided for similarly providing mechanical support to the foldable cover 31F in its on-state. In general, the support 36 of FIG. 3G is similar to that of FIG. 3F, except that the middle surfaces of the support 36 may not be connected to each other and that each of such middle surfaces may be coupled to preset portions of the cover 31F. Thus, when the door 10 opens, the middle surfaces of the support 36 may also move toward their on-state inside the gap 15 along with the cover 31F which may also move toward its on-state. When the door moves to its (fully) open position, such middle surfaces of the support 36 may reach their (fully) on-state and support the cover 31F against external force and preventing movement of the cover 31F toward the gap 15 in response to such force. As the door 10 begins to close, such middle surfaces of the support 36 may be folded toward their off-state along with the cover 31F, and completely folded and disposed between the rear and coupling ends 12R, 22 in their (fully) off-state, waiting for next opening movement of the door 10.

In another aspect of the present invention, another exemplary cover member may have at least one stackable cover which may be arranged to be stacked one over the other in its off-state and then to be unstacked and cover at least a portion of the gap in its on-state, where FIGS. 4A through 4D are perspective views of various stackable cover members with at least one stackable cover and where FIGS. 4E to 4G show perspective views of various stackable cover members of FIGS. 4A to 4D in their on-states according to the present invention.

In one exemplary embodiment and as shown in FIG. 4A, a door safety system 30 may include multiple stackable covers 31S which may be aligned in a row and movably coupled to each other by at least one coupler 34. The stackable covers 31S may be arranged to be stacked one over another by overlapping at least substantial portions thereof, thereby forming a stack or a bundle of covers 31S in its off-state, and then to be unstacked from such a stack by moving away from each other until being restrained by the coupler 34 in its on-state. Operational characteristics of such stackable covers 31S may also be characterized as described in the aforementioned co-pending application. In general, the stackable covers 31S may be movably coupled to each other by the coupler 34 such as, e.g., a string or strings as commonly seen in conventional blades of a blind. The stackable cover 31S also includes a first end 33A and a second end 33B, where the former may be coupled to the rear end 12R of the door 10, while the latter may be coupled to the coupling end 22 of the frame 20. Other configurational and operational characteristics of such stackable covers 31S may be found in the above co-pending application.

In operation, at least a substantial number of such stackable covers 31S may be disposed one over another and form a stack in their (fully) off-state when the door 10 is in its (fully) closed position. As the door 10 opens, the first end 33A may move along with the door 10, while the second end 33B may be fixedly coupled to the frame 20. Accordingly, some of the stackable covers 31S may begin to be removed from the stack and move with the door 10 in a covering (or unstacking) direction along a covering (or unstacking) path while increasing a total length of the unstacked covers 31S. When the door moves to its (fully) open position, at least a substantial number of such covers 31S may move to their (fully) on-state, attain its covering length, and cover a preselected portion of the gap 15. As the door 10 begins to close, the unstacked covers 31S may be pushed back toward their off-state by the door 10 through its first end 33A or may be pulled toward their off-state by a recoil unit (not shown in the figure). Therefore, such covers 31S may begin to form the stack by being disposed one over the other while returning to such a stack in an uncovering (or stacking) direction along an uncovering (or stacking) path. Depending upon modes of stacking and/or unstacking, the unstacked covers 31F may be arranged to be sequentially stacked one after the other or, in the alternative, at least a substantial number of the covers 31S may be uniformly pushed closer to each other and join the stack. When the door 10 is completely shut to its (fully) closed position, all of the unstacked covers 31S may return to the stack to its (fully) off-state and its uncovering length, thereby allowing the cover 31S to uncover the preset portion of the gap 15.

In another exemplary embodiment and as shown FIG. 4B, a door safety system 30 may include multiple stackable covers 31S which may be similar to those of FIG. 4A. Such a system 30, however, includes a housing 32 which may be arranged to receive and retain at least a portion of such covers 31S when the door 10 is in its closed position and the covers 31S are in its off-state, where a number of such covers 31S stacked in the housing 32 may be determined by various factors such as, e.g., a depth or a height of the housing 32, a thickness of each cover 31S, and the like. It is appreciated that the housing 32 may be disposed in an orientation capable of receiving and releasing the covers 31S in a direction transverse or normal to the above stacking and/or unstacking directions. The housing 32 may also be disposed similar to that of FIG. 3B. In a related exemplary embodiment and as described in FIG. 4C, a system 30 may include similar covers 31S and a similar housing 32, except that the latter may be oriented to receive and release such portions of the cover 31F along a direction which may be parallel to the above stacking and/or unstacking directions. Further configurational and/or operational characteristics of the systems of FIGS. 4B and 4C may be similar or identical to those of the systems of FIGS. 3B, 3C, and 4A.

It is appreciated that the stackable covers may be arranged to have various shapes and sizes as far as they may be stacked and unstacked while covering the preset portion of the gap. Therefore and in another exemplary embodiment as described in FIG. 4D, such a system 30 may include covers 31S which may be generally similar to that of FIG. 4A but form angled top and bottom lines so that the covers 31S may define folded polygonal sections along their lengths. The stackable covers 31S may define other shapes and/or sizes as well, as described in the aforementioned co-pending application. Other configurational and/or operational characteristics of such a system of FIG. 4D may be similar or identical to those of the systems of FIGS. 3D and 4A to 4C.

Any of the above stackable covers may be incorporated between the rear end of the door and the coupling end of the frame. FIGS. 4E to 4G show several examples of the stackable covers in their on-states, where their first and second ends are respectively coupled to the rear and coupling ends. It is appreciated, however, that these figures only represent top portions of such covers, doors, and frames for simplicity of illustration.

In one exemplary embodiment and as shown in FIG. 4E, a guide 35 may be provided in order to offer mechanical integrity to the stackable cover 31S and/or to guide the cover 31S during movements between its off- and on-states. In general, such a guide 35 is similar to that of FIG. 3E, except that the guide 35 of FIG. 4E may be releasably disposed behind or in front of the stackable cover 31S. Further configurational and operational characteristics of the guide may also be found in the aforementioned co-pending application.

In another exemplary embodiment and as depicted in FIG. 4F, a support 36 may be provided for offering mechanical support to the stackable covers 31S in its on-state. The support 36 may typically be similar to that of FIG. 3F, and include at least one middle surface which may not be directly coupled to the stackable covers 31S and may be arranged to be folded and unfolded as such covers 31S may be stacked and unstacked between their off- and on-states, respectively. Other configurational and operational characteristics of such a support 36 may be similar or identical to those of the support of FIG. 3F.

In another exemplary embodiment and as shown in FIG. 4G, a support 36 may be provided for similarly providing mechanical support to the stackable covers 31S in its on-state. The support 36 of FIG. 4G may be generally similar to that of FIG. 3G such that the middle surfaces of such a support 36 may be coupled to preset stackable covers 31S. Accordingly, such a support 36 may be folded and unfolded when the stackable covers 31S may be stacked and unstacked between their off- and on-states, respectively. Other configurational and operational characteristics of such a support 36 may be similar or identical to those of the support of FIG. 3G.

In another aspect of the present invention, an exemplary cover member may instead include at least one rollable cover which may be arranged to be rolled in its off-state and then to be unrolled and cover at least a portion of the gap in its on-state, where FIGS. 5A to 5C show perspective views of various rollable cover members including at least one rollable cover, and where FIGS. 5D to 5F depict perspective views of various rollable cover members of FIGS. 5A to 5C in their on-states according to the present invention.

In one exemplary embodiment and as shown in FIG. 5A, a door safety system 30 may have at least one rollable cover 31R as well as at least one optional roller 37. Such a rollable cover 31R may be arranged to be unrolled from (or rolled out of) the roller 37 and to extend in a covering (or unrolling) direction along a covering (or unrolling) path as the roller 37 rotates in a preset direction. Conversely, the rollable cover 31R may also be arranged to be rolled unto (or around) the roller 37 and to retract in an uncovering (or unrolling) direction along an uncovering (or unrolling) path as the roller 37 rotates in an opposite direction. In the exemplary embodiment of FIG. 5A, the rollable cover 31R is a rectangular strip, and the roller 37 is a cylinder having an axial length which is slightly greater than a length of the rollable cover 31R. In this example, the covering and uncovering directions are generally transverse to a longitudinal axis of the roller 37 and parallel to edges of the cover 31R. Characteristics of rolling (or covering) and/or unrolling (or uncovering) of the rollable cover sheet 31R may be characterized by an index such as a degree of rolling which may be defined in an arbitrary scale but preferably range from 0.0 (when an entire portion of the rollable cover 31R is rolled out of the roller 37) to 1.0 (when the entire cover sheet 31R is rolled onto or around the roller 37). Accordingly, the rollable cover 31R may have along an uncovering length with a high degree of rolling in its off-state, and extend along a covering length with a low degree of rolling in its on-state. The rollable cover 31R may also include at least one first end 33A and at least one second end 33B, where the former may couple with the rear end 12R of the door 10, while the latter may be coupled to the coupling end 22 of the frame 20. It is appreciated that, depending upon their coupling modes, either of the ends 33A, 33B may be referred to as the fixed end 33X or as a free end 33R. Other configurational and operational characteristics of such rollable cover 31R may be found in the above co-pending application.

In operation, at least a substantial portion of the rollable cover 31R is rolled around the roller 37 and the cover 31R is kept to its uncovering length when the door 10 is in its closed position. When the door 10 begins to open, the first end 33A which may be fixedly coupled to the door 10 may also begin to move therewith, whereas the second end 33B which may fixedly couple with the frame 20 may not move. Thus, the cover 31R may begin to be unrolled and pulled out of the roller 362, while increasing its length in the covering direction along the covering path both of which are generally transverse or normal to the edges of the cover 31R. When the door 10 moves to its (fully) open position, the cover 31R may also move to its (fully) on-state in which at least a substantial portion of the cover 31R may be pulled or unrolled out of the roller 37 and in which such a cover 31R may attain its covering length, thereby covering the preset portion of the gap. As the door 10 begins to close, the rollable cover 31R may be pushed toward its off-state by the door 10 through its first end 33A or may be pulled toward to its off-state by the elastic unit along the uncovering direction. Thus, such a cover 31R may shorten its length in the uncovering direction along the uncovering path both of which may also be traverse or normal to the edges of the cover 31R. When the door is completely shut to its (fully) closed position, at least a substantial portion of the rollable cover 31R may be also rolled onto the roller 37 to its (fully) off-state, thereby uncovering the preset portion of the gap.

In another exemplary embodiment and as shown in FIG. 5B, a door safety system 30 may have at least one rollable cover 31R which is generally similar to that of FIG. 5A. The system 30, however, includes a housing 32 which may be arranged to receive and retain at least a portion of the cover 31R when the door 10 is in its closed position and the cover 31R is in its off-state, where an amount of the portion of the cover 31R retainable inside the housing 32 may be determined by various factors such as, e.g., a depth or height of the housing 32, a thickness of the cover 31F, a radius or diameter of the roller 37, and so on. The housing 32 may also be disposed similar to those of FIGS. 3B and 4B. Other configurational and operational characteristics of such a system of FIG. 5B may be similar or identical to those of the system of FIG. 5A.

It is appreciated that such rollable covers may be arranged to have various shapes and sizes as long as they may be rolled and unrolled while covering the preset portion of the gap. Accordingly and in another exemplary embodiment as described in FIG. 5C, such a system 30 may include a cover 31R which may be typically similar to that of FIG. 5A but form curved top and bottom lines so that the cover 31R may define curvilinear polygonal sections along its length. The rollable cover 31F may also define other shapes and/or sizes as well, as described in the aforementioned co-pending application. Other configurational and/or operational characteristics of the system of FIG. 5C may also be similar or identical to those of the systems of FIGS. 5A and 5B.

Any of the above rollable covers may be incorporated between the rear and coupling ends of the door-frame assembly. FIGS. 5D to 5F describe several examples of the rollable covers in their on-states, where their first and second ends are respectively coupled to the rear and coupling ends. It is appreciated that these figures represent top portions of such covers, doors, and frames for simplicity of illustration.

In one exemplary embodiment and as shown in FIG. 5D, a rollable cover 31R may be arranged to incorporate supports 36 which may be embedded along a length and/or height of the cover 31R and provide mechanical integrity and strength in its on-state. Thus, when an user inadvertently pushes or presses the rollable cover 31R, such a cover 31R may resist the force and continue to cover a preset portion of the gap 15.

In another exemplary embodiment and as depicted in FIG. 5E, a guide 35 may also be provided in order to offer mechanical integrity to the rollable cover 31R and/or to guide such a cover 31S during movements between its off- and on-states. Such a guide 35 is generally similar to that shown in FIG. 3E, except that the guide 35 of FIG. 5E may be releasably disposed behind or in front of such a cover 31R. Other configurational and operational characteristics of the guide may be found in the above co-pending application.

In another exemplary embodiment and as depicted in FIG. 5F, a support 36 may be provided for offering mechanical support to the rollable cover 31R in its on-state. The support 36 may typically be similar to those of FIGS. 3F and 4F, and include at least one middle surface which may not be directly coupled to the rollable cover 31R and may be arranged to be folded and unfolded as such cover 31R may be rolled and unrolled between its off- and on-states, respectively. Other configurational and/or operational characteristics of such a support 36 may be similar or identical to those of the support of FIGS. 3F and 4F.

In another aspect of the present invention, an exemplary cover member may instead include at least one slidable cover which may be arranged to slide away from the gap in its off-state and then to slide out and cover at least a portion of the gap in its on-state. FIGS. 6A to 6D are perspective views of various rollable cover members including at least one slidable cover, while FIGS. 6E to 6G describe perspective views of various slidable cover members of FIGS. 6A to 6D in their on-states according to the present invention.

In one exemplary embodiment and as shown in FIG. 6A, a door safety system 30 may have at least one slidable cover 31S and be equipped with one or more of various provisions to guide such a cover 31E through the movements of between its off- and on-states. Such a slidable cover 31E may define at least one first end 33A and at least one second end 33B, where the former may couple with the rear end 12R of the door 10, while the latter may couple with the coupling end 22 of the frame 20. In one example, the second end 33B may define a vertical slit 38 which may be arranged to releasably or movably receive the slidable cover 31E therethrough, and to respectively expose and unexpose at least a portion of the slidable cover 31E with respect to one side of the holder, thereby covering and uncovering a preset portion of the gap respectively along a covering direction (or path) and along an uncovering direction (or path). In another example, an optional holder may be provided to movably or releasably receive the cover 31S therethrough and to allow the cover 31S to slide sideways. In the embodiment of FIG. 6A, the slidable cover 31E has a rectangular shape and is made of a rigid material, where the covering and uncovering directions may be typically normal or transverse to the slit 38 and parallel to side edge of the cover 31S. Characteristics of sliding movements of the slidable cover 31E may be assessed using an index such as a degree of exposure which may be defined in an arbitrary scale but preferably range from 0.0 (when an entire or at least a substantial portion of the cover 31E is disposed on a left side of the slit 38 and away from the gap 15) to 1.0 (when such a portion of the cover 31E is disposed on a right side of the slit 38 and exposed inside the gap 15). Thus, the slidable cover 31E may be disposed away from the gap 15 having an uncovering length and a low degree of exposure in its off-state, and exposed to have a covering length with a high degree of exposure in its on-state. It is appreciated that, depending upon their coupling modes, either of the ends 33A, 33B may also be referred to as the fixed end 33X or a free end 33R. Further configurational and/or operational characteristics of such slidable cover 31E may be found in the above co-pending application.

In operation, at least a substantial portion of the slidable cover 31E is disposed on the left side of the slit 38 while defining the uncovering length in its off-state as the door 10 is in its closed position. As the door 10 begins to open, the first end 33A coupling with the door 10 begins to move therewith, while the second end 33B fixedly coupling with the frame 20 may not move. Therefore, the cover 31E may begin to be pulled toward the right through the slit 38 in the covering direction while increasing its length along the covering path. When the door 10 moves to its (fully) open position, the slidable cover 31E may also move to its (fully) on-state in which at least a substantial portion of the cover 31E may slide toward the gap and attain its covering length, thereby covering the preset portion of the gap. As the door 10 begins to close, the slidable cover 31E may be pushed toward its off-state by the door 10 through the first end 33A in the uncovering direction along the uncovering path or similarly pulled to its off-state by the elastic unit, thereby decreasing its exposed length. As the door 10 is completely shut to its (fully) closed position, at least a substantial portion of the slidable cover 31E may slide to the left side of the slit 38 to its (fully) off-state, thereby uncovering the preset portion of the gap.

In another exemplary embodiment and as shown in FIG. 6B, a door safety system 30 may have at least one slidable cover 31E which may be generally similar to that of FIG. 6A as well as a housing 32 which may be arranged to receive and retain at least a portion of the slidable cover 31E in its off-state when the door 10 is in its closed position. It is appreciated that the housing 32 of FIG. 6B may be similar to or different from the housings shown in FIGS. 3B, 4B, and 5B. For example, contrary to the housings of those figures which are arranged to retain various portions of various covers therein, the housing 32 of FIG. 6B may preferably be arranged to change an orientation of the slidable cover 31E so as to dispose the portion of the cover 31E which is not recruited in covering the gap 15 inside the gap 15 and/or between the rear and coupling ends of the door-frame assembly. Accordingly, such a housing 32 of FIG. 6B may be arranged to retain at least a portion but not necessarily an entire portion of the unrecruited portion of the slidable cover 31E therein. Thus, an amount of the portion of such a cover 31E retainable in the housing 32 may be determined by various factors such as, e.g., a depth or height of the housing 32, a thickness of the cover 31F, and the like. The housing 32 may be disposed similar to those of FIGS. 3B, 4B, and 5B. Other configurational and operational characteristics of such a system of FIG. 6B may be similar or identical to those of the system of FIG. 6A.

It is appreciated that the slidable covers may be arranged to have various shapes, sizes, and orientations as far as they may slide in and out away from and toward the gap 15, respectively, so as to uncover and cover the preset portion of the gap. Therefore and in another exemplary embodiment as described in FIG. 6C, a system 30 may include a guide 35 which is implemented to the second end 33B and arranged to change an orientation of the cover 31E by about 90 degrees. Therefore, at least a portion of the cover 31E may be disposed beside the second end 33B in its off-state, and may slide out toward its on-state while varying its orientation to extend across the gap 15, thereby covering the preset portion of the gap 15. Thereafter, the exposed portion of the slidable cover 31E may slide back toward its off-state while varying its orientation to become parallel to the second end 33B. In a related exemplary embodiment of FIG. 6D, a system 30 may include a pair of guides 35A, 35B, where the first guide 35A is arranged to orient a slidable cover 31E parallel to the second end 33B, while the second guide 35B may be disposed along an exposed edge of the second end 33B and arranged to change a direction of the slidable cover 31E 180 degrees. Therefore, the cover 31E may extend from a hidden edge of the second end 33B toward the exposed edge thereof, move away from such a second end 33B, turn 180 degrees about the second guide 35B, and then extend toward the first end 33A. Other configurational and/or operational characteristics of the systems of FIGS. 6C and 6D are also similar or identical to those of the systems of FIGS. 6A and 6B.

Any of the above slidable covers may be incorporated between the rear and coupling ends of the door-frame assembly. FIGS. 6E to 6G describe several examples of the slidable covers in their on-states, where their first and second ends are respectively coupled to the rear and coupling ends. It is appreciated that these figures represent top portions of such covers, doors, and frames for simplicity of illustration.

In one exemplary embodiment and as shown in FIG. 6E, a slidable cover 31E may be made of and/or include at least one material exhibiting at least minimal mechanical integrity and strength enough to resist external force. Thus, when an user inadvertently pushes or presses the slidable cover 31E, it may resist the force and continue to cover a preset portion of the gap 15. In the alternative, such a cover 31E may also incorporate supports of FIG. 5D which may be embedded along a length and/or a height of the cover 31E and provide mechanical integrity and strength in its on-state. It is appreciated that the slidable cover 31E of FIG. 6E is arranged to slide through a slit 38 of a second end 33B while exposing at least a substantial portion thereof in both of its off- and on-states.

In another exemplary embodiment and as depicted in FIG. 6F, a guide 35 may also be provided in order to offer mechanical integrity to the slidable cover 31E and/or to guide such a cover 31E during movements between its off- and on-states. Such a guide 35 is generally similar to that shown in FIGS. 3E and 5E and releasably disposed behind or in front of such a cover 31E. Other configurational and operational characteristics of the guide may be found in the above co-pending application.

In another exemplary embodiment and as shown in FIG. 6G, a support 36 may be provided for offering mechanical support to the slidable cover 31E in its on-state. The support 36 may typically be similar to those of FIGS. 3F, 4F, and 5F and have at least one middle surface which may not be directly coupled to the slidable cover 31E and may be arranged to be folded and unfolded when such a cover 31E may slide sideways between its off- and on-states, respectively. Further configurational and/or operational characteristics of such a support 36 may be similar or identical to those of the support of FIGS. 3F, 4F, and 5F.

In another aspect of the present invention, an exemplary cover member may instead include at least one deformable cover which may be arranged to undergo configurational changes between its on- and off-states in order to respectively cover and uncover at least a portion of the gap. FIGS. 7A to 7X are perspective views of various deformable cover members including at least one deformable cover according to the present invention. It is appreciated that the figures employ a door and a frame both of which are identical to those of the above figures.

A first group of exemplary embodiments are shown in FIG. 7A to 7F which show perspective views of various deformable covers in their off-state (FIG. 7A) and in various on-states (FIGS. 7A to 7F). In one exemplary embodiment of FIG. 7B, a deformable cover 31D may be made of and/or include at least one deformable material and disposed between the rear end 1 2R of the door 10 and coupling end 22 of the frame 20, where only one or both ends of the cover 31D may be fixedly or releasably coupled to one or both of the rear and coupling ends 12R, 22. Accordingly, such a cover 31D may fill the preset portion of the gap 15 in its on-state. It is appreciated that the deformable cover 31D may be arranged to operate in its fully stressed state, partially stressed state, partially unstressed state, and fully unstressed state in its off-state, and then to undergo the configurational change to be in another of such states. For example, such a cover 31D may be fully or partially compressed or squeezed in its off-state, and then at least partially restore its unstressed configuration in its on-state. Conversely, the cover 31D may be in or near its unstressed state in its off-state, and then expanded or stretched in its on-state. As long as such a cover 31D may fill or occupy the preset portion of the gap 15 in its on-state, detailed configuration of the cover 31S and designation of the stressed or unstressed states of the cover 31D may be a matter of choice for one of ordinary skill in the relevant art.

In other exemplary embodiments of FIGS. 7C to 7F, deformable covers 31D may be constructed similar to that of FIG. 7B, except that such covers 31D may define therein at least one hole or void 41, at least one opening 42, and so on. For example, the deformable cover 31D of FIG. 7C may define the symmetric opening 42 in its rear portion, where such an opening 42 may correspond to a truncation of the rear portion of the cover 31D, while the cover 31D of FIG. 3D may include the symmetric hole 41 in its interior. In addition, the deformable cover 31D of of FIG. 7E may include the symmetric opening 42 which extends from its rear portion into its front, whereas the cover 31D of FIG. 7F may instead have the asymmetric opening preferentially provided on one side thereof. The embodiments of FIGS. 7C to 7F may offer a benefit over that of FIG. 7B. For example, the cover of FIG. 7B may have to be overly compressed or squeezed in its off-state when such a cover may attain its unstressed configuration in its on-state or, conversely, may have to be overly stretched in its on-state when the cover attains its unstressed state in its off-state. In contrary, the deformable covers 31D shown in FIGS. 7C to 7F may generally have less mass or volume than that of FIG. 7B and, therefore, may alleviate such excessive compression or stretching, thereby preventing or minimizing irreversible configurational damage to the covers and lengthening a life of such covers. Other configurational and/or operational characteristics of the covers 31D of FIGS. 7C to 7F are similar or identical to those of the cover of FIGS. 7A and 7B.

A next group of exemplary embodiments are shown in FIG. 7G to 7J which show perspective views of various deformable covers in their off-state (FIG. 7G) and in various on-states (FIGS. 7H to 7J). In one exemplary embodiment of FIG. 7H, a deformable cover 31D may be provided as a sheet of at least one elastic material which may preferably be biased to its stressed state and disposed inside the gap 15. Such a cover 31D includes a first end 33X which is fixedly coupled to the rear end 12R of the door 10 as well as a second end 33R which is not coupled to the coupling end 22 of the frame 20. Accordingly, the free second end 33R may be disposed in various positions along the coupling end 22 depending upon a size of the gap 15.

In operation, such a deformable cover 31D is at least substantially bent between the rear and coupling ends 12R, 22 in its off-state when the door 10 is in its closed position, i.e., such a cover 31D is biased to its stressed state. When the door 10 begins to move toward its open position, the gap 15 gradually increases its size. In proportion therewith, the deformable cover 31D gradually changes its configuration, namely, expands toward its unstressed state while abutting the rear and coupling ends 12R, 22 with its fixed and free ends 33X, 33R, respectively. As the door 10 reaches its open position, the gap 15 attains its maximum size, and the deformable cover 31D also expands to its greatest extent such that the free end 33R travels from a rear portion of the coupling end 22 toward a front portion of such an end 22, while positioning its middle portion out of the gap 15, thereby blocking access to the preset portion of the gap 15 in its on-state. As the door 10 begins to move toward its closed position, the gap 15 begins to shrink, while the deformable cover 31D begins to be flattened toward its biased position. When the door 10 reaches its closed position, the cover 31D is flattened and bent around its middle portion, while the free end 33R of such a cover 31D also travels back to the rear portion of the coupling end 22.

In another exemplary embodiment of FIG. 71, a deformable cover 31D may be provided similar to that of FIG. 7H but further includes an indentation 39 thereon. In addition, a guide 35 is provided on the coupling end 22 of the frame 20 in order to match a position and size of the indentation 39 of the cover 31D in its off-state. Accordingly, when the door 10 moves from its open position to its closed position, the guide 35 may suppress and guide the cover 31D toward its off-state. As the door 10 approaches its fully closed position, the indentation 39 of the cover 31D gradually receives the guide 35 therein so as to prevent excessive suppression of the cover 31D by the guide 35. This embodiment may offer a few advantages. For example, such a guide 35 may decrease a contact area between the cover 31D and coupling end 22 of the frame 20, thereby reducing a frictional force therebetween and facilitating movements of the cover 31D between its off- and on-states. In addition, the indentation 39 may not only prevent excessive suppression of the cover 31D in its off-state but also releasably lock such a cover 31D in its off-state. The shape and/or size of the indentation may be typically determined by the shape and/or size of the matching guide 35 which may be formed as a protrusion on the coupling end 22 of the frame 20, which may include a roller or wheel so as to facilitate the movements of the cover 31D, and so on. In another exemplary embodiment of FIG. 7J, a deformable cover 31D may be formed similar to that of FIG. 7H but arranged to operate differently from that of FIG. 7H. For example, such a cover 31D may be arranged to have a “U” or “V” shape so that its first end 33X fixedly couples with the rear end 12R of the door 10 and that its second end 33R also moves along such a rear end 12R. Accordingly, the cover 31D forms a bent middle portion which moves along the coupling end 22 of the frame 20 while extending across the preset portion of the gap 15 and also blocking access to such a portion of the gap 15. Other configurational and/or operational characteristics of such a cover 31D of FIGS. 71 and 7J are similar or identical to those of the covers of FIGS. 7G and 7H.

A next group of exemplary embodiments are shown in FIGS. 7K to 7P which show perspective views of various deformable covers in their off-state (FIGS. 7K, 7M, and 70) and in various on-states (FIGS. 7L, 7N, and 7P). In one exemplary embodiment shown in FIGS. 7K and 7L, a deformable cover 31D may be provided as a sheet of at least one elastic or non-elastic material which may preferably be disposed outside of the gap 15 in both of its off- and on-states. Such a cover 31D also includes the first and second ends both of which are fixedly coupled to the rear and coupling ends 12R of the door 10 and coupling end 22 of the frame 20.

In operation, at least a substantial or entire portion of the deformable cover 31D is exposed out of the gap 15 in its off-state when the door 10 is in its closed position. Because the first and second ends of the cover 31D are fixedly coupled to the rear and coupling ends 12R, 22, the cover 31D may be wound in this state. As the door 10 begins to move toward its open position, the gap 15 gradually increases its size, and the deformable cover 31D gradually changes its configuration, namely, opens up or spreads out. When the door 10 reaches its fully open position, the deformable cover 31D also spreads out to its fully on-state and covers the gap 15, thereby blocking access to the preset portion of the gap 15 in its on-state. As the door 10 begins to move toward its closed position, the cover 31D also begins to be rolled toward its off-state while being exposed outside the gap 15. As the door 10 reaches its fully closed position, the cover 31D is wound or rolled around its middle portion to its off-state.

In another embodiment of FIGS. 7M and 7N, a deformable cover 31D may be constructed similar to that of FIGS. 7K and 7L. However, such a cover 31D also defines a rigid back portion and a flexible or elastic front portion which is contiguous with the back portion. Accordingly, an end of the flexible or elastic front portion forms the first end which couples with the rear end 12R of the door 10, while the rigid back portion forms the second end which couples with the coupling end 22 of the frame 20. In addition, lengths of such front and back portions may be selected so that the cover 31D may define a rather flat configuration in its off-state, that the front portion is exposed, and that the back portion is preferably disposed close to the frame 20 and hidden behind the front portion. The rigid back portion of the cover 31D may also be arranged to fixedly couple with the second end and/or front portion at a preset angle in order to attain the configuration exemplified in the figures. Other configurational and/or operational characteristics of the cover 31D of FIGS. 7M and 7N are similar or identical to those of the cover of FIGS. 7K and 7L.

In another embodiment of FIGS. 70 and 7P, a deformable cover 31D may be constructed similar to that of FIGS. 7M and 7N, except that a rigid back portion is formed substantially shorter than that of FIGS. 7M and 7N. Accordingly, the rigid portion of the cover 31D may bulge out less than that of FIGS. 7M and 7N. Because of such a shorter rigid portion, however, the cover 31D may be rolled or wound in its off-state. Other configurational and/or operational characteristics of the cover 31D of FIGS. 70 and 7P are similar or identical to those of the cover of FIGS. 7K to 7N.

Another embodiment is described in FIGS. 7Q and 7R which are perspective views of another deformable cover disposed respectively in its off- and on-states. Such a deformable cover 31D may be made of and/or include at least one elastic material and fabricated similar to those of FIGS. 7G to 7P or may be made of and/or include at least one flexible or rigid material and fabricated as a sheet. The frame 20 is arranged to include a guide 35 on or around an edge between the coupling end 22 and an adjacent surface so that the cover 31D may extend from the first fixed end 33X toward the guide 35, wind or wrap around the guide 35, and extend into the gap 15 after changing its orientation by such a guide 35. In this context, such a cover 31D may be viewed as a special type of the rollable covers as described in FIGS. 5A to 5F and, therefore, any of the above features related to such rollable covers may also be applied to the deformable cover 31D of FIGS. 7Q and 7R. As depicted in the figures and when the cover 31D is made of or includes materials which may not exhibit recoil properties, at least one recoil unit 50 may be incorporated into the second end of the cover 31D and provide such recoil force for returning the cover 31D from its on- to off-state. Even when the cover 31D may exhibit the recoil characteristics, such a recoil unit 50 may be implemented thereto in order to augment the recoil force.

Another embodiment is described in FIGS. 7S and 7T which are perspective views of another deformable cover disposed respectively in its off- and on-states. Such a deformable cover 31D may be constructed as a conventional bellow which are coupled to the rear and coupling ends by the first and second ends thereof. Therefore, such a cover 31D may close and open up between its off- and on-states. In this context, such a cover 31D may be viewed as a special type of the foldable covers as described in FIGS. 3A to 3G. Accordingly, any of the above features related to the foldable covers may be applied to the cover 31D of FIGS. 7S and 7T. When the cover 31D may be made of or include materials which may not exhibit recoil characteristics, at least one recoil unit may be incorporated into the second end of the cover 31D and provide the recoil force for returning the cover 31D from its on- to off-state. Even when the cover 31D may exhibit the recoil characteristics, the recoil unit 50 may be implemented thereto in order to augment the recoil force. In addition, various guides and/or supports may also be incorporated thereto when desirable.

Any of the above deformable covers of FIGS. 7A to 7T may be replaced by equivalents thereof each including multiple segments at least one of which may be deformable, although such equivalents may define slightly different contour in their off- and/or on-states. FIGS. 7U and 7V show perspective views of an exemplary deformable cover which may include multiple segment in its off- and on-states, respectively. A deformable cover 31D includes a right segment and a left segment, where the former is coupled to the rear end 12R of the door 10, while the latter is coupled to the coupling end 22 of the frame 20. In addition, such segments may be arranged to abut each other in both of their off- and on-states, while changing their configurations between their stressed and unstressed states depending upon movements of the door 10 and space of the gap 15. In this context, the cover 31D of FIGS. 7U and 7V may be a functional equivalent of, e.g., that of FIGS. 7G and 7H. Other configurational and/or operational characteristics of such a cover 31D may be similar or identical to those of other covers of FIGS. 7A to 7T.

In addition, a door safety system including any of the above deformable covers of FIGS. 7A to 7V may include or define a housing capable of receiving and retaining at least a portion of the covers in their off-states. FIGS. 7W and 7X show perspective views of exemplary door safety systems each including a housing. For example, a system 30 of FIG. 7W defines a housing 32 in the coupling end 22 of the frame 20, where the housing 32 is shaped and/or sized to receive and retain the second end of the cover 31D in its off-state. As shown in the figure, the housing 32 may be disposed inside a hole or an indentation provided in or along the coupling end 12R. In the alternative, the frame 20 itself may be carved out to form such a hole or indentation into which the cover 31D may be movably disposed. In the alternative, a system 30 of FIG. 7X defines at least one curvilinear track 43 extending inside the frame 20 and capable of receiving and retaining at least a portion of the cover 31D.

In both of the cover members of FIGS. 7W and 7X, such a housing and/or track may be shaped and/or sized according to the shapes and/or sizes of the cover to be received and retained thereby, directions and/or paths of the movements of the cover between its off- and on-states, and the like. In addition, such a housing and/or track may be arranged so that the received portion of the cover may be in the unstressed or stressed state. It is appreciated that such housings and/or tracks may also be applicable to all other covers disclosed hereinabove so that at least a portion of the foregoing foldable, stackable, rollable, slidable, and/or deformable cover may be received and retained inside the housing or along the track in its off-state and that such a portion of the cover may move out of the housing or track in its on-state.

Such a track may be practiced by various means. For example, the door and/or frame may be carved out into a preset depth according to a preset contour. When the track needs to be provided to a certain depth and/or contour which may not be easily carved out, such a door and/or frame may be provided as an assembly of multiple segments as exemplified by a dashed line drawn in a top portion of the frame of in FIG. 7X, where such segments are to be coupled to each other and where the track may be provided between the segments. Other configurational and/or operational characteristics of the covers of FIGS. 7W and 7X are similar or identical to those of other covers of FIGS. 7A to 7W.

Configurational and/or operational variations and/or modifications of the above embodiments of the exemplary cover members and various covers thereof described in FIGS. 3A through FIG. 7X also fall within the scope of this invention.

The gap generally refers to a space which is formed between the rear end of the door and the coupling end of the frame and to be covered by various covers in their partially and/or fully on-states. Accordingly, a precise dimension and/or shape of the gap is generally determined by various factors such as, e.g., a dimension, shape, size, and/or orientation of the door, those of the frame, a direction and/or path of at least one of the opening and closing movements of the door relative to the frame or gap, and so on. Such characteristics of the gap may affect various configurational and/or operational characteristics of the cover member and/or covers thereof such as, e.g., its dimension, shape, size, arrangement, orientation, installation mode and/or location, movement direction and/or path, disposition of its on- and/or off-states, and the like. For example, when the door opens and closes laterally, the gap is typically defined laterally in order to include a space encompassed by the door moving between its open and closed positions. The cover member may be advantageously disposed across or in front of above at least a portion of the gap in order to protect the user. However, when the door rotates or pivots radially about the axis of rotation, the gap may be preferably defined between the coupling and rear ends, and the cover may be disposed inside, across, over, and/or in front of the gap.

Such a door may move or rotate between multiple open and/or closed positions such as, e.g., a fully closed position, at least one partially closed position, at least one partially open position, a fully open position, and so on. Movements of such a door between such positions may be continuous or incremental, gradual or instantaneous, and so on. Such movements of the doors may be effected by the user or by a conventional electrical or mechanical device of which the operation is based upon an input command, presence or absence of the user in or near the gap, and so on. The cover members or their covers may also move between multiple on- and/or off-states such as, e.g., a fully off-state, at least one partially off-state, at least one partially on-state, a fully on-state, and the like. The covers may also generate various movements between the above states, where such movements may also be continuous or incremental, gradual or instantaneous, and the like. It is appreciated, however, that instantaneous uncovering movements of such covers may not necessarily be desirable or achievable due to hardware limitations as described above.

The above cover members or, more particularly, their covers may be arranged to have various shapes and/or sizes as described above. More particularly, such covers may be arranged to define different shapes and/or sizes in their on- and off-states. As long as the covers may move between such states and cover the preset portion of the gap in their on-states, such covers may define almost any arbitrary shapes and/or sizes.

It is appreciated that all of the above exemplary cover members share a common feature, i.e., they may change at least one of its configurations and/or have at least one different configuration in their on- and off-states. Examples of such configurations may include, but not be limited to, a length, a width, and/or a height measured along a longitudinal and/or vertical axis of of the cover, a horizontal and/or vertical thickness and/or elevation measured across various portions of the cover, a radius or diameter measured about an axis of rotation of the cover, a curvature or contour measured along a surface of the cover, an arrangement of and/or between the covers, an overlap between the covers, an angle formed along various portions of the cover, a slope of the surface of the cover, a molecular or microscopic structure of the cover, and the like. In addition, the radius or diameter may include the inner and outer dimensions, while the length, width, height, thickness, and elevation may include those measured along the linear, arcuate, and/or curved covering or uncovering paths or directions. When the system may include a housing, these configurations may also include those retained inside such a housing and/or those exposed out of the housing. Thus, such configurations may include the above configurations of the cover retained in the housing by being, folded, stacked, rolled, and/or otherwise moving therein or thereacross, those configurations of the cover exposed out of the housing by being unfolded, unstacked, unrolled, and/or otherwise moving therefrom.

The foregoing covers may be directly or indirectly coupled to the door and/or frame by various embodiments. For example and as exemplified in some of the figures, the cover may include at least one first end and at least one second end on its opposing ends, where the first end is coupled to the door (or frame), while the second end is coupled to the frame (or door). Such first and second ends may be fixedly coupled to the cover or form an unitary article therewith, or may be releasably coupled thereto such that the user may first install the first and/or second ends to the door or frame and install the cover therebetween thereafter. Alternatively, the door and/or frame may be arranged to form one or both of such ends, while the cover may include only one or none of such. It is appreciated that, as long as the cover member and/or its cover may be installed between the movable door and stationary frame, detailed coupling configuration and inclusion of such ends are generally matters of selection of one of ordinary skill in the relevant art.

At least a portion of such a cover may be made of and/or include at least one elastic or flexible material, e.g., such that the cover may bend, fold or otherwise change its configuration along the top and/or bottom lines. Such an embodiment may prove beneficial when at least a portion of the cover is arranged to be folded, stacked, rolled, and/or sled into the housing defining dimensions different from those of the cover, e.g., by allowing such a cover to deform and to be retained inside such a housing. The cover may also include multiple segments which fixedly and/or movably couple with each other. Such segments may also be arranged to have different configurations and/or mechanical properties such as, e.g., elasticity, transparency, and the like, thereby accommodating various covering and/or uncovering movements of the cover, to enhance visibility therethrough, and the like. In addition, such a cover may include one or both of the first and second ends in order to be coupled to the door and/or frame. However, when the connectors or couplers are to be implemented into the door and/or frame, the cover itself may not include none of the first and second ends. It is appreciated that such elastic or flexible cover may also be made of rigid materials which are movably coupled to each other in order to exhibit apparent elasticity or flexibility.

The cover member may include multiple covers of the same or different dimensions, types, and the like. For example, multiple covers of the same type may be movably coupled at preset angles and arranged to move between their on- and off-states in order to cover the preset portion of the gap at multiple directions and/or angles. Alternatively, multiple covers of different types may be coupled at preset angles and arranged to move between their on- and off-states as well. Whether they may be of the same or different types, multiple covers may also be coupled or connected to each other along a direction transverse to or in parallel with the covering and/or uncovering directions, with or without any overlap therebetween. Such multiple covers may also be directly connected to each other or, in the alternative, indirectly connected to each other by employing conventional rigid or elastic couplers or connectors which may or may not provide any slack between a top, bottom, and/or side of such multiple cover sheets. Thus, such couplers or connectors may be arranged to accommodate different movements of the covers in their covering and/or uncovering directions. In addition, multiple covers may have identical or different configurations and/or mechanical properties such as, e.g., modulus or elasticity.

The covers may be arranged to change the cross-sections defined along the covering and/or uncovering directions and/or along directions normal or angled with respect to such covering and/or uncovering directions between their on- and off-states. For example, such covers may change their cross-sections by including a rigid structure defining a stressed, flat shape in its off- or on-state and an unstressed, extended shape in its on- or off-state. Alternatively, such covers may include shape-memory materials capable of changing their cross-section in response to external force.

The door safety system may also include various optional guides arranged to support or guide the cover member and/or their covers during their covering and uncovering movements. Such guides may be fixedly installed to the door and/or frame and define a preset path in which the cover member and/or sheet may movably travel. Alternatively, such guides may be arranged to extend and retract along with the movements of the cover between the on- and off-states and to guide such movements of the cover. Detailed configurations and operations of such guides are generally matters of selection of one of ordinary skill in the art, and may be found in the aforementioned co-pending application.

The foldable covers may have configurations which may be different from those exemplified in FIGS. 3A to 3G. For example, such top and bottom lines may be provided on the cover at least partially parallel to each other, may extend along different directions to form angles, and may be two- or three-dimensional. Because the lines may be formed in almost any configurations, the curvilinear polygonal sections defined therebetween may also be arranged to have a variety of configurations so that each section may define a length, width, height, thickness, radius, diameter, elevation, and/or angle which may be uniform or may change along its longitudinal and/or vertical axes or along the covering and/or uncovering paths. In addition, such a polygonal section may have a symmetric or asymmetric shape. Multiple polygonal sections may also be arranged to have uniform or different shapes and/or sizes, to be disposed according to a symmetric or asymmetric arrangement, to be two- or three-dimensional, and so on. When desirable, such covers may be arranged to be folded and unfolded not along the top and/or bottom lines. In addition, such covers may also be arranged to be folded and unfolded along or at a preset angle with respect to the covering and/or uncovering directions.

The foldable covers may move in the covering and uncovering directions or paths which are generally normal or transverse to the top and/or bottom lines thereof, where such covering paths are typically identical to the uncovering paths but their directions are opposite. Alternatively, the covering paths or directions may be different from the uncovering paths or directions. In addition, the covering and uncovering paths or directions may be linear and/or curved (e.g., circular, oval, angular, arcuate, and so on), two or three-dimensional, and so on. Such paths or directions may also be horizontal or vertical, angled or slanted, upward or downward, arcuate, rotational, and/or extending outwardly or retracting inwardly in relation to the door, frame, and/or gap.

Depending upon the covering and/or uncovering patterns, the polygonal sections of the cover may be arranged to be sequentially folded and/or unfolded one after another from left to right or vice versa, where the degree of folding may incrementally decrease or increase when the cover covers or uncovers the portion of the gap, respectively. Alternatively, the cover may be unfolded and folded uniformly throughout the entire portion thereof, where the degree of folding may uniformly decrease or increase as the cover respectively covers or uncovers such a portion of the gap.

The stackable covers may be arranged to have configurations different from those of FIGS. 4A to 4G. First of all, it is appreciated that the stackable covers may be deemed to be generally similar to the foldable covers, except that the polygonal sections of the foldable covers are contiguous, while the stackable covers are not. Therefore, all of the above variations and/or modifications regarding the foldable covers equally apply to each of the stackable covers.

The stackable covers may be arranged to have an identical shape and size such that they may form a stack having the same length and/or width as the individual cover. Alternatively, the stackable covers may also have different shapes and/or sizes, e.g., their lengths and/or widths increasing (or decreasing) from a top to a bottom of the stack, increasing (or decreasing) from the top to a middle of the stack and then decreasing (or increasing) to the bottom of the stack, and so on. When desirable, the covers may also have different shapes and/or sizes without any preset pattern in order to cover the selected portion of the gap having irregular shapes and/or sizes.

Such stackable covers may be connected or coupled to each other by various embodiments. For example, at least a substantial number of the covers may be connected to each other sequentially by at least one string or other conventional connectors or, alternatively, each pair of adjacent covers may be separately connected to each other by such strings or connectors. In both embodiments, the covers may be arranged to form protrusions or matching grooves, depressions or indentations, and the like, so as to facilitate coupling of adjacent covers, while optionally restraining such covers from moving beyond preset ranges. Alternatively, the covers may have apertures through which the string or other connectors are inserted to fixedly or movably couple the covers. Regardless of the coupling mechanism, such strings or other connectors may be made of or include at least one elastic material so as to provide elasticity to the covers. In addition, the above protrusions, grooves, and/or apertures may be provided in any desirable locations on the covers such as, e.g., in their top, middle or bottom portions, as long as they may allow the covers to move between their on- and off-states.

Similar to the foldable counterparts, such stackable covers may be arranged to be sequentially unstacked (or stacked) one after another from a top to a bottom of the stack (or vice versa). In such an embodiment, the degree of stacking may decrease (or increase) gradually, the degree of overlap may become lower (or higher) for the top cover and higher (or lower) for the bottom cover, and the like, while the covers may cover (or uncover) the selected portion of the gap. In the alternative, such covers may be unstacked (or stacked) uniformly throughout the entire stack, where both degrees of stacking and overlap may uniformly decrease (or increase) when the cover member may cover (or uncover) the preset portion of the gap.

Such stackable covers move in the covering and uncovering directions (or paths) which may be generally similar or identical to those for the foldable covers as described above. In addition, such stackable covers may be comprised of multiple segments which are coupled to each other vertically, horizontally or at angles. When desirable, some covers may have different dimensions and/or define different mechanical properties from the rest of the covers in order to generate various uncovering or covering movements in various covering or uncovering directions (or paths) which may identical to or different from the covering directions. In addition, such covering and uncovering directions (or paths) may be linear and/or curved (e.g., circular, oval, angular or arcuate), two or three-dimensional, and so on. Such paths or directions may be horizontal or vertical, angled or slanted, upward or downward, arcuate, rotational, and/or extending outwardly or retracting inwardly with respect to the door, frame, and/or gap.

The rollable covers may be arranged to define configurations which are different from those exemplified in FIGS. 5A to 5F. For example, such rollable covers may define almost any shapes and/or sizes as far as such covers may be rolled onto and out of the matching roller between their on- and off-states. Therefore, the rollable cover may have the shapes of the rectangle, square, triangle, arc, truncated arc, trapezoid, circle, oval, ellipse, hexagon, and/or other curvilinear polygons. The rollable cover may be arranged to have a perimeter and/or cross-section varying along its longitudinal and/or vertical directions. The cover may also be arranged to be two- or three-dimensional, and its covering and/or uncovering directions may be identical to or different from each other. The rollable cover may be arranged to be symmetric relative to such directions, in the alternative, to be asymmetric in order to cover and uncover the preset portion of the gap. It is appreciated that the rollable cover and its roller may have to be arranged to match each other when such a cover is generally rigid. However, such a cover and/or roller do not have to exactly match each other when the cover is made of and/or include at least one elastic or flexible material, because such a cover may easily conform to the roller during its covering and uncovering movements.

The rollable cover may include multiple segments coupled to each other horizontally, vertically or at angles. Some segments may be arranged to have different dimensions or mechanical properties from the rest in order to generate various covering or uncovering movements along various covering or uncovering directions (or paths).

At least a portion of the rollable cover also be arranged to be elastic or flexible in order to vary its shape, slope, curvature, contour, and/or angle during its covering and uncovering movements. The cover may be arranged to change its cross-section by, e.g., elongation or stretching thereof, between its stressed and unstressed states which may correspond to its on- and off-states, respectively (or vice versa). Alternatively, the cover may include at least one shape-memory material so as to change its shapes including its cross-section in response to external force.

The slidable covers may further be arranged to define configurations which are different from those exemplified in FIGS. 6A to 6G. For example, such a cover may define almost any shapes and/or sizes such as, e.g., a triangle, rectangle, trapezoid, square, arc, truncated arc, and other curvilinear polygons having straight and/or curved sides. Such covers may also be arranged to be symmetric or axisymmetric with respect to the covering and/or uncovering directions or the axis of rotation thereof. Therefore, the shapes and/or sizes of the holder and its slit may be arranged to accommodate such covers and to allow the covering and/or uncovering movements thereof.

Similar to other covers, the slidable cover may be arranged to form two- or three-dimensional shapes, and their covering and uncovering directions may be identical to, similar to or different from each other. The slidable cover may also include multiple segments coupled to each other and having identical, similar or different dimension and/or physical properties.

At least a portion of the slidable cover may be made of or include at least one elastic or flexible material in order to vary its dimensions, slope, contour, curvature, and/or angle during the movements between its on- and off-states. The cover may also be arranged to change its cross-section by, e.g., elongation or stretching thereof, between its stressed and unstressed states which may correspond to its on- and off-states, respectively (or vice versa). Alternatively, such a cover may include at least one shape-memory material to change its shapes including its cross-section in response to external force. Such a slidable cover may not be used with the above holder depending upon coupling modes thereof. For example, the holder may be incorporated into the door and/or frame or, in the alternative, a portion of the door and/or frame may be designed to perform similar functions as the holder.

It is to be understood that such a slidable cover may be constructed by incorporating different configurational and/or operational characteristics of other covers described heretofore. For example, a given cover may be arranged to adopt certain configurations of the rollable cover as well as certain operational characteristics of the slidable covers. As long as such a cover may change at least one configuration thereof and cover at least a portion of the gap in its on-state, detailed configurational or operational characteristics thereof may merely be a matter of selection for one of ordinary skill in the relevant art.

Because the gap formed between the rear end of the door and coupling end of the frame may have only limited dimensions, a preset portion of such a gap may be covered by a single cover which may be one of the above foldable, stackable, rollable, and slidable covers. It is appreciated in such an embodiment that a single cover of a certain type may define at least substantially similar dimensions as another single cover of a different type. However, such a single cover may operate through different mechanisms depending on how such a cover may move between its off- and on-states. Therefore, a single foldable cover may be folded onto and unfolded from one or both of the first and second ends, a single stackable cover may be stacked and unstacked from such ends, a single rollable cover may be rolled onto and out of a roller, and a single slidable cover may slide sideways, thereby covering the preset portion of the gap.

The foregoing cover may generally be arranged to fixedly or releasably couple with the frame and door, where both of the first and second ends of the cover may serve as the fixed ends. In this embodiment, the cover operates from one to the other of its off- and on-states while changing at least one configuration defined between such first and second ends. In the alternative, at least one of the first and second ends may not be coupled to the rear end of the door or the coupling end of the frame, where such an uncoupled end may serve as a free end which may be disposed in different positions in its off- and on-states. For example, the slidable covers exemplified in FIGS. 6A through 6G include the first ends which are all fixedly coupled to the rear end of the door (thus, coupled ends) as well as the second ends which couple with neither the door nor the frame (thus, free ends). In contrary, the foldable and stackable doors of FIGS. 3A to 4G include the first and second ends which are coupled to the rear and coupling ends, respectively, and serve as the fixed ends. As will be described below, however, some deformable covers may be arranged so that they may not define any specific ends or that their first and second ends may not be coupled to the door and frame. In the latter embodiment, the deformable cover may be directly or indirectly coupled to the door or frame through other portions thereof as will be described in greater detail below.

It is appreciated that the above covers may be coupled to the door and/or frame according to different embodiments. For example, various covers exemplified in the above figures include the first ends which are fixedly or releasably coupled to the rear end of the door as well as the second ends which are fixedly or releasably coupled to the coupling ends of the frame. Such coupling modes may be reversed such that the first end of the cover may be fixedly or releasably coupled to the coupling end of the frame or another surface which may be transverse or normal to such an end, whereas the second end of the cover may similarly couple with the rear end of the door or another surface which may be transverse or normal to such an end. As far as the cover may be arranged to cover a preset portion of the gap, designation of the first and second ends as well as selection of the fixed and free end may merely be a matter of choice for one skilled in the relevant art.

Similarly, the housing may be disposed on the coupling end of the frame as exemplified in the foregoing figures or, in the alternative, may be disposed on another surface of the door which may be transverse or normal to the coupling end. In addition, the housing may instead be disposed on the rear end of the door or another surface thereof which may also be transverse or normal to the rear end. In addition, the above slits, rollers, guides, and/or supports may also be disposed on or near the rear end of the door.

It is appreciated that any of the above covers may also be made of and/or include a variety of materials exhibiting various mechanical properties. Therefore, when the cover may be made of and/or include at least one material which exhibits at least minimum mechanical integrity and/or modulus in the on-state, such a cover may not necessarily be guided or supported by the above guide or supports. Thus, when the user inadvertently pushes or presses the cover 31E in its on-state, it may resist the force and continue to cover the preset portion of the gap. Conversely, when the cover may not have such properties, such a cover may be guided by various guides and/or may be supported by various supports, where further details of such guides and supports may be found in the aforementioned co-pending application.

The deformable covers of FIGS. 7A to 7F are arranged to occupy or fill a preset portion of the gap in their on-states, thereby blocking an access into the gap. Because such deformable covers are disposed between the rear and coupling ends, such covers may be bound to be subject to squeezing, compression, stretching, and the like. Thus, such covers may preferably be made of and/or include at least one material which may change its volume as well as its shape in response to the movements of the door.

It is appreciated that such deformable covers may be disposed between the rear and coupling ends according to various embodiments. For example, the covers may be fixedly coupled to the rear and coupling ends through their first and second ends. Alternatively, such covers may fixedly couple with one of the rear and coupling ends through one of their first and second ends, while the other of the first and second ends may serve as the free end. In either embodiment, such covers may readily be implemented in position.

Such deformable covers may need at least minimal mechanical strength in order to maintain its integrity. Thus, such covers may preferably be made of and/or include such materials. Alternatively, at least one support may be disposed around the covers and/or embedded therein so as to enhance their mechanical strength.

The deformable covers of FIGS. 7A to 7F may include a variety of holes and/or openings along their heights. Such holes and/or openings may have various shapes and/or sizes and may also vary their shapes and/or sizes along their heights. In addition, the covers may include multiple holes and/or openings as long as they may facilitate the configurational changes of the covers between their off- and on-states. Accordingly, an exact number of such holes and/or openings and detailed disposition thereof may be a matter of choice for those skilled in the art.

When desirable, the housing as described in conjunction with other covers of FIGS. 3A to 6G may be provided in one or both ends of the deformable covers in order to receive and retain at least a portion of such covers in their off-state, and then to release such a portion in their on-state. Such a housing may be fabricated as those exemplified in FIGS. 3A to 6G or, in the alternative, a portion of the rear and/or coupling ends may be carved out to form such a housing as exemplified in FIG. 7C.

The deformable covers of FIGS. 7G to 7J are arranged to extend across the preset portion of the gap and block access to such a portion of the gap in their on-states. Because such deformable covers are disposed between the rear end of the door and the coupling end of the frame, the covers are bound to be subject to compression in their off-states. Therefore, such covers may preferably be made of and/or include at least one material which may change its shape between such states.

It is appreciated that such deformable covers may be arranged to have various cross-sections in their off- and on-states. The foregoing figures exemplify the covers having the cross-sections of a “L or C,” “U or V,” and the like. However, such deformable covers may define other cross-sectional shapes and their free ends may travel along the rear or coupling end or may move between such rear and coupling ends as far as they may block access to the preset portion of the gap in their on-states. Other configurational and/or operational characteristics of the covers of FIGS. 7G to 7J are similar or identical to those of the covers of FIGS. 7A to 7F.

At least one recoil unit may be incorporated into such deformable covers in order to augment a recoil force for returning the covers from their on- to off-states and to guide such covers to or toward their off-states. For example, the recoil unit such as an elastic spring or string may be disposed so as to couple the second end of the cover to the rear end of the door. When applied to the above covers such as, e.g., those of FIGS. 7H to 7J, such a recoil unit may bias such covers in their on-state toward a front of the gap and/or may dispose at least portions of the covers to bulge out from the gap and/or outwardly therefrom, thereby more effectively preventing the user from accidentally disposing his or her body part in the gap.

Such a recoil unit may also be employed to bias at least a portion of the cover in its off- and/or on-states so as to position the cover in a preferred disposition and/or orientation. When applied to the above figures such as, e.g., FIGS. 7K to 7P, such a recoil unit may bias not only the rigid back portion of the cover toward the door and/or frame but also the flexible or elastic front portion thereof toward the door and/or frame.

The deformable covers of FIGS. 7K to 7P are arranged to extend between the rear end of the door and coupling end of the frame, thereby blocking access to the preset portion of the gap in their on-states. Thus, special provisions may be made for these deformable covers in order to preferably dispose at least a substantial portion thereof outside the gap in both of their off- and on-states. For example, such a deformable cover may be made of and/or include at least one elastic material which is biased or stressed toward the gap space such that the cover may tend to bulge outwardly toward its unstressed state. Such a cover may tend to remain outside the gap as the door closes toward its closed position. In another example, one of the guides and/or supports may be implemented into such a cover in order to ensure that such a portion of the cover may always be disposed outside the gap. Other configurational and/or operational characteristics of the covers of FIGS. 7G to 7J are similar or identical to those of the covers of FIGS. 7A to 7F.

As exemplified in FIGS. 7U and 7V, any of the foregoing deformable covers may be arranged to include multiple segments at least one of which may operate between its off- and on-states. Such a cover may include two or more symmetric segments which are disposed symmetrically with respect to each other. In the alternative, such a cover may employ two or more asymmetric segments which may be disposed asymmetrically. Regardless of such symmetry, multiple segments of the cover may be arranged to have at least substantial identical mechanical properties such that such segments may operate along similar paths between their off- and on-states. Alternatively, such segments may also have different mechanical properties so that one of such segments may play a major role in blocking the preset portion of the gap, while the other of such segments may play a minor role therein. As long as such multiple segments may be arranged to operate between their off- and on-states and to block the preset portion of the gap, detailed number of such segments, disposition thereof, and operational details thereof may merely be matters of choice of one of ordinary skill in the relevant art.

All of the above covers may preferably be designed to facilitate easy installation thereof. For example, when the cover requires coupling of only one of the first and second ends to only one of the rear end of the door and coupling end of the frame, the other end of the cover which may not need be coupled is preferably arranged to be flexible in order to allow the user to couple the one end of such a cover to the door or frame and then to properly position the cover in place. When both of the first and second ends of the cover may have to be coupled to the door and frame, such ends of the cover may be arranged to be releasably coupled to the door and frame. For example, the user may install nails or other couplers on the door and frame, and then simply insert matching couplers onto such couplers on the door and frame. As long as such couplers may allow the cover to be properly coupled to the door and frame and may not obstruct intended functions of such a cover, details of such couplers are not material to the scope of the present invention.

In another aspect of the present invention, the above cover members and/or their covers may be arranged to be in at least one temporal relation or synchronization with the movements of the door between its positions. FIG. 8 is a series of schematic diagrams for exemplary temporal relations or synchronization between movements of the above exemplary cover members and/or doors according to the present invention.

A top diagram represents a status of the door, where an abscissa represents time and where an ordinate is a position of the door between its closed and open positions. An event D₁ is a timing (or moment) when the door begins to move toward its (fully) open position from its (fully) closed position, while an event D₂ is a timing when the door reaches its (fully) open position. Accordingly, a slope of a line connecting these two points, D₁ and D₂, represents a speed of the door opening from its closed position to its open position. Similarly, an event D₃ is a timing when the door begins to close toward its (fully) closed position from its (fully) open position, whereas an event D₄ is a timing when such a door reaches its (fully) closed position. A slope of a line connecting these two points, D₃ and D₄, therefore, represents a speed of the door closing from its open position to its closed position.

In contrary, subsequent diagrams labeled from (A) to (J) denote various states of any of the above exemplary cover members and/or their covers, where an abscissa is time and an ordinate is a position of the cover members or covers thereof between their on- and off-states. More particularly, various events designated in the diagrams (A) to (J) are marked along a time frame which is identical to that for marking the foregoing events, D₁ to D₄, of the top diagram, in order to synchronize various events of the door with those of the cover members, sheets, and/or sheds. Therefore, diagrams (A) to (E) show various events associated with the covering movements of the cover members and their covers, while diagrams (F) to (J) denote various events associated with their uncovering movements.

In the diagram (A), one of the foregoing cover begins to move from its off-state toward its on-state in a timing, U₁, and may then reach its (fully) on-state in one of timings, C_{F1}, C_{F2}, C_{F3}, C_{F4}, and C_{F5}, where the timing, C_{F1}, is a moment before D₁ (i.e., when the door is kept in its (fully) closed position), the timing, C_{F2}, is a moment of D₁ (i.e., as the door starts to open from its closed position), the timing, C_{F3}, means a moment after D₁ but prior to D₂ (i.e., after the door begins to move but before the door reaches its (fully) open position), the timing, C_{F4}, is a moment of D₂ (i.e., when the door reaches its (fully) open position), and lastly the timing, C_{F5}, is a moment after D₂ but prior to D₃ (i.e., after the door reaches its (fully) open position but before the door begins to close). Because the covers of the first two examples such as U₁-C_{F1} and U₁-C_{F2} move to their on-states before the door begins to move, they may cover a preset portion of the gap before a person may move the door. In contrary, the covers of the next three embodiments, U₁-C_{F3}, U₁-C_{F4} and U₁-C_{F5}, may start to cover the portion of the gap but may not reach their (fully) on-states before the door moves. Thus, such a cover of U₁-C_{F3} may cover only a small portion of the gap when the door starts to move, an incrementally greater portion thereof as the door opens and continues to move toward its open position, and then a greater portion of the gap before the door moves to its fully open position. Alternatively, the cover of U₁-C_{F4} may cover only a small portion of the gap as the door starts to move, an incrementally greater portion thereof when the door opens and continues to move toward its fully open position, and the greatest portion of such a gap when the door reaches its fully open position. The cover of U₁-C_{F5} operates generally similar to that of U₁-C_{F4}, except that such a cover may cover the entire preset portion of the gap after the door reaches its fully open position.

In the diagram (B), the cover starts to move from its off- toward its on-state in a timing, U₂, and then reaches its (fully) on-state in one of timings, C_{F3}, C_{F4}, and C_{F5}, which have been defined in the diagram (A). In all of these embodiments, the covers may move from their off-states to their on-states simultaneously with or when the door begins to open from its closed to its open position. Accordingly, such covers may cover only a small portion of the gap when the door starts to move, an incrementally greater portion as the door opens and continues to move toward its open position, and then the entire preset portion of the gap before the door moves to its fully open position (U₂-C_{F3}), as the door reaches its fully open position (U₂-C_{F4}), or after the door reaches its fully open position (U₂-C_{F5}). The foregoing covering movements of the covers may be easily practiced, e.g., by mechanically coupling the cover with the door. Because the covers of U₂-C_{F3} and U₂-C_{F5} do not reach their fully on-states precisely as the door reaches its fully open position, the covers may optionally be moved by the user or actuator member which may have optional sensors and/or conversion units.

In the diagram (C), the cover begins to move from its off-state toward its on-state in a timing, U₃, and reaches its (fully) on-state in one of timings, C_{F3}, C_{F4}, and C_{F5}, as described heretofore. In all embodiments, such covers move from their off-states toward their on-states after the door starts to open from its closed position toward its open position but before such a door reaches its fully open position. Accordingly, such covers may cover only a small portion of the gap after the door starts to open, an incrementally greater portion thereof as the door moves closer to its fully open position, and the entire preset portion of the gap before the door moves to its fully open position (U₃-C_{F3}), when the door reaches its fully open position (U₃-C_{F4}), or after the door reaches its fully open position (U₃-C_{F5}). Other operational characteristics of the foregoing exemplary temporal relations are similar or identical to those of the foregoing diagrams (A) and (B).

In the diagrams (D) and (E), such covers may begin to move from their off-states toward their on-states in other timings, U₄ and U₅, and then reach their (fully) on-states in a timing, C_{F5}, where U₄ is the timing when the door reaches its fully open position, U₅ is the timing after the door reaches its fully open position, and C_{F5} has been defined above. Other operational characteristics of such exemplary temporal relations are similar or identical to those of the foregoing diagrams (A) to (C).

In the diagram (F), one of the above covers may start to close from its (fully) on-state toward its (fully) off-state in a timing, C₁, and reach its fully off-state in one of timings, U_{F1}, U_{F2}, U_{F3}, U_{F4}, and U_{F5}, where the timing, U_{F1}, is a moment before D₃ (i.e., when the door is kept in its fully open position), the timing, U_{F2}, is a moment of D₃ (i.e., when the door starts to close from its open position), the timing, U_{F3}, means a moment after D₃ but prior to D₄ (i.e., after the door begins to close but before the door reaches its fully closed position), the timing, U_{F4}, is a moment of D₄ (i.e., as the door reaches its fully closed position), while the timing, U_{F5}, is a moment after D₄ (i.e., after the door reaches its fully closed position. In contrary, the covers of the next three embodiments, C₁-U_{F3}, C₁-U_{F4}, and C₁-U_{F5}, similarly start to uncover such a portion of the gap before the door begins to close but reach its fully off-state before the door reaches its fully closed position (C₁-U_{F3}), as the door reaches the position (C₁-U_{F4}), or after the door reaches such a position (C₁-U_{F5}).

In the diagram (G), the cover starts to move from its on-state toward its off-state in a timing, C₂, (i.e., as the door starts to close) and reaches its (fully) open position in one of timings, U_{F3}, U_{F4}, and U_{F5}, which have been defined in the diagram (F). Accordingly, such covers may cover the entire preset portion of the gap as the door starts to close, uncover incrementally greater portions of the gap as the door moves toward its closed position, and uncover the entire preset portion of such a gap before the door moves to its fully closed position (C₂-U_{F3}), as the door reaches its fully closed position (C₂-U_{F4}), or after the door reaches its fully closed position (C₂-U_{F5}). Such uncovering movements of the covers may be easily practiced, e.g., by mechanically coupling the cover with the door. However, because the covers of C₂-U_{F3} and C₂-U_{F5} may not reach their fully off-states precisely as the door reaches its fully open position, such covers may also be moved by the operator or actuator member with optional sensors and/or conversion units.

In the diagram (H), the cover begins to move from its on-state toward its off-state in a timing, C₃, and reaches its (fully) off-state in one of timings, U_{F3}, U_{F4}, and U_{F5}, as described heretofore. In all embodiments, the covers may move from their on-states toward their off-states after the door starts to move from its open position toward its closed position, but before the door reaches its fully closed position. In addition, such covers may uncover only a small portion of the gap after the door starts to close, an incrementally greater portion as the door moves closer to its fully closed position, and then the entire preset portion of such a gap before the door moves to its fully open position (C₃-U_{F3}), as the door reaches its fully closed position (C₃-U_{F4}), or after the door reaches its fully closed position (C₃-U_{F5}). Other operational characteristics of such exemplary temporal relations are similar or identical to those of the foregoing diagrams (F) and (G).

In the diagram (I), the cover may begin to move from its on-state toward its off-state in another timing, C₄, and reach its fully off-state in one of timings, U_{F4} and U_{F5}, where C₄ is the timing when the door reaches its fully closed position and U_{F4} and U_{F5} have been defined heretofore. In the diagram (J), the cover may begin to move from its on-state toward its off-state in another timing, C₄, which is the timing after the door may reach its fully closed position. Other operational characteristics of such exemplary temporal relations are similar or identical to those of the foregoing diagrams (F) to (H).

Configurational and/or operational variations and/or modifications of the above embodiments of the exemplary temporal relations for the cover systems and various cover members thereof described in FIG. 8 also fall within the scope of this invention.

The foregoing exemplary temporal relations are described with reference to the fully open and closed positions of the door and the fully off- and on-states of the covers. Such relations may readily be applied to the doors moving between or through partially open and/or closed positions and/or to the covers moving between or through partially on- and/or off-states. The only difference between such doors and/or cover members from those of FIG. 8 is that vertical distances along the ordinates may be shorter for such doors and/or covers moving between the partial positions and states, respectively.

Various covers of the present invention may be arranged to employ any of the above covering temporal relations exemplified in the diagrams (A) to (E) and/or any of the above uncovering temporal relations exemplified in the diagrams (F) to (J). Accordingly, the cover may move from its off- to on-state before, as or after the door moves from its closed to open position, and may also move from its on- to off-state before, as or after the door moves from its open to closed position.

The above covering and uncovering movements of the covers may be generated by numerous modes. In one exemplary embodiment, such movements may be manually generated by an user of the door. In one example, the system may include at least one handle with which the user may manually move the cover from its off- to on-state. In another example, the cover may have at least one switch arranged to activate the actuator member moving such a cover from its off- to on-state. Examples of such actuator members may include, but not limited to, conventional electrical, mechanical, pneumatic, and magnetic motors. In yet another example, the system may include at least one sensor for sensing movements, presence, or absence of the user or object disposed in or moving across the gap, motion sensors for detecting the movements of the door, position or displacement sensors for detecting the position of the door, sensors for measuring a period of the door in its open or closed position, sensors for monitoring the cover in its on- or off-state, and the like.

As described herein, various covers may be directly and/or indirectly coupled to the door so as to move at least substantially simultaneously with the door. In this embodiment, the covering and/or uncovering movements of the cover may be determined by the opening and/or closing movements of the door. Alternatively, the movements of the cover may be generated by the user and/or the actuator member in order to optionally render such movements of the cover independent of the movements of the door. Therefore, the cover may move between its on- and off-states at preset timings, at preset intervals, within preset periods from occurrences of preset events such as, e.g., opening or closing of the door, appearance or disappearance of the user or object in the gap, and so on. In addition, the covers and doors shown in FIG. 8 may move at constant speeds (as exemplified by straight lines with constant slopes connecting different events) or at variable speeds (not shown in the figure) such that the covers may move faster or slower than the doors.

Such covers may also be arranged to change the speeds of their covering and/or uncovering movements in order to accommodate various design considerations thereof. For example, when such a cover is directly coupled to the door, the speeds of movements of such a cover may be determined by those of the door. Thus, when the user abruptly opens or closes the door with excessive force or speed, the cover may not be able to catch up with such force or speed, inflicting mechanical damages onto the cover. In order to prevent such, the system may include at least one viscous unit capable of dissipating at least a portion of energy of mechanical shock and dampening the movements of such a cover compared to the movements of the door. In this regard, the door safety system of this invention may be used in conjunction with conventional door checks. The system may also include at least one gear assembly for increasing or decreasing the speeds of the movements thereof compared to those of the door. In either embodiment, the cover may be arranged to reach its off- and/or on-states before and/or after the door reaches its closed and/or open positions. The system may also include at least one mechanical device for providing offsets such that the cover may not move until the door moves a preset distance, until the covering and/or uncovering forces and/or acceleration may reach a preset value, and so on. Such a mechanical device may be arranged to provide a preset time lag between the movements of the cover and those of the door. Alternatively, the system may include the actuator member controlled by an electrical controller providing similar offsets, time lags, timing functions, and the like.

The system may also include at least one conversion unit arranged to change timings and/or temporal characteristics of such covering and/or uncovering forces and/or movements generated by the user and/or actuator member. For example, the conversion unit may be arranged to receive one of such forces from the user and/or actuator member and to deliver one of such forces to the cover at a preset timing and/or after a preset period of time. Examples of such conversion unit may include, but not limited to, mechanical devices with offset forces or displacements, mechanical devices having viscous dampers to dissipate energy, mechanical devices providing time lags, electrical devices with control capabilities, and the like. It is appreciated that the actuator member with or without the above optional sensor and/or conversion units may also be arranged to move the cover independent of the movements of the door, i.e., before, simultaneously with or after the door moves from its off- to on-state or vice versa.

In another aspect of the present invention, the foregoing cover members or their cover moving between their on- and off-states may further be arranged to be in at least one complementary relation with the doors moving between their open and closed positions. More particularly, at least a portion of such covering and/or uncovering forces for the covers may be generated by the opening and/or closing forces of the door, with or without accompanying any of the foregoing temporal relations. To this end, the door safety system of this invention may include at least one force generating member for generating, storing, and/or releasing force (or energy) which may be arranged to at least partially cause one of the covering and/or uncovering movements of the above cover members or covers. For example, at least one of the movements of the cover between its on- and off-states may be arranged based upon the complementary relation to at least one of the movements of the door between its open and closed positions. By definition, the cover moves from its off- to on-state by a covering force, and moves from its off- to on-state by an uncovering force, where one of such forces may be arranged based upon the complementary relation to the other thereof. Such forces may be extension versus compression force, torques acting in opposite or different directions, and the like.

Various force generating members may be used in conjunction with the cover members and/or covers thereof. Exemplary force generating members may include at least one recoil unit which may be arranged to couple with the cover and/or door, to receive force and store at least a portion thereof while deforming from an unstressed state to a stressed state, and then to release the stored force, while returning itself back to the unstressed state. In general, such a recoil unit may include one or more conventional springs examples of which may include, but not be limited to, cylindrical or conical coil springs, flat or curved spiral springs, leaf springs, torque springs, torsion bars, and the like. The spring may be a compression spring to be compressed in the stressed state or an extension spring to be stretched or elongated in its stressed state. Such a spring may be a constant force spring with a constant spring constant or a variable spring with a spring constant which varies with its length. The recoil unit may further include other elastic elements such as, e.g., cross-curve materials, snap tapes, stampings, extension round wires, compression or tension round wires, and so on (all available from Vulcan Springs Work, Telford, Pa.). The force generating member may also have at least one viscous unit which may couple with the cover, door, and/or recoil unit, to receive force, and then to dissipate at least a portion thereof during its movement. The viscous unit may include at least one viscous dash pot, and examples of such may include, but not be limited to, shock absorbers, fluid dampers, liquid die springs, and the like (all available from Taylor Devices, Inc., North Tonawanda, N.Y.). FIGS. 9A to 9C show perspective views of exemplary recoil units for complementary relations between movements of exemplary cover members and doors according to the present invention.

In one exemplary embodiment, FIG. 9A is a schematic view of an exemplary force regenerating member exhibiting one complementary relation (or synchronization). An exemplary system 30 typically has at least one slidable cover 31S, a force generating member such as recoil units 50, a damper 51, and a housing 32. The slidable cover 31S has a first end 33A and a second end 33B, and the housing 32 includes a holder 32H and defines an inner space to retain an unexposed portion of the cover 31S therein. The holder 32H may be provided on one end of the housing 32 to allow movements of such a cover 31S therethrough. The cover 31S is coupled to the housing 32 by a pair of recoil units 50 and a viscous unit such as the damper or a dash pot 51 through its second end 33B such that the recoil and viscous units 50, 51 may be pulled and/or stretched to their stressed states by external force applied by the user or actuator member, and then returned to their unstressed states thereafter.

In operation, when the door is kept in its closed position, the slidable cover 31S is disposed in its off-state, and the recoil and viscous units 50, 51 are disposed in their unstressed states in which they may not exert any force onto the slidable cover 31S. As the cover 31S begins to move from its off-state toward its on-state by the covering force which is provided by the user or actuator member, the recoil units 50 receive energy associated with the covering force and then store at least a portion of the energy while being stretched or elongated along the covering direction. Accordingly, the recoil units 50 begin to exert recoil force by pulling the cover 31S back to its off-states along the uncovering direction. When the cover 31S moves to its on-state by the covering force (which of course exceeds the recoil forces for the time being) and covers a preset portion of the gap, the recoil units 50 extend to their stretched states, store at least a portion of the energy in proportion to the lengths extended beyond their unstressed lengths, and exert the recoil force. After a preset period of time or when the cover 31S receives an uncovering signal issued by the user and/or actuator member, the recoil units 50 may release the stored energy and begin to exert the recoil force, thereby pulling the slidable cover 31S toward its off-state along the uncovering direction. Therefore, such recoil units 50 may provide at least a portion of the uncovering force in a complementary relation with the covering force directly or indirectly supplied by the user or actuator member. As the cover sheet 31S reaches its off-state, the recoil units 50 may reach their unstressed state and stop to exert the recoil force or, alternatively, may not reach the unstressed state but apply the recoil force of a less magnitude due to restoration of at least a substantial portion of its length beyond the unstressed state, thereby uncovering the preset portion of the gap. The optional viscous unit 51 may adjust or change the covering and/or uncovering movements of the cover 31S based upon the characteristics of the elasticity of the recoil units 50 and viscosity thereof and exhibit overdamped, critically damped or underdamped response.

In another exemplary embodiment, FIG. 9B describes a schematic view of another exemplary force generating member exhibiting another exemplary complementary relation (or synchronization). An exemplary system 30 has a rollable cover 31R, another force generating member 50, a housing 32, a holder 32H, and so on. The housing 32 and its holder 32H are generally similar to those of FIG. 9A, while the rollable cover 1R is arranged to toll onto and then out of a roller 37 which is disposed in the housing 32. The exemplary force generating member includes at least one recoil unit 50 such as the flat spiral spring or torque spring disposed in one end of the roller 37 and rotating about a longitudinal axis of the roller 37. Therefore, the recoil unit 50 may be wound to its stressed state and unwound to recoil back to its unstressed state. Such a system 30 also includes at least one guide 32G disposed apart from the roller 37 and guiding the rollable cover 31R in a preset elevation.

In operation, the rollable cover 31R is disposed in its off-state and the recoil unit 50 is disposed in its unstressed state. As the cover 31R begins to be pulled away by a covering force and rolled out of the roller 37 toward its on-state, the spring of the recoil unit 50 is wound toward its stressed state while storing at least a portion of the energy associated with the covering force and exerting a recoil force in a direction opposite to a covering direction. As the cover 31S moves toward its on-state and covers a preset portion of the gap, the recoil unit 50 is wound to its stressed state, stores a greater portion of the energy, and exerts a stronger recoil force. When the covering force stops to apply, the recoil unit 50 releases the stored energy so as to pull the cover 31S toward its off-state. Thereafter, the rollable cover 31R returns to its off-state and then uncovers the preset portion of the gap as the recoil unit 50 consumes all or most of the stored energy or when the first end 33A is restrained by the holder 32H. Other configurational and/or operational characteristics of the force generating member of FIG. 9B are similar or identical to those of FIG. 9A.

In another exemplary embodiment, FIG. 9C is a schematic view of yet another exemplary force generating member for another exemplary complementary relation (or synchronization). An exemplary system 30 includes multiple stackable covers 31S, a force generating member, and a housing 32. The stackable covers 31S define a first end 33A, and are arranged to stack inside and to unstack out of the housing 32 which in turn defines a holder 32H similar to those of FIGS. 9A and 9B. The exemplary force generating member includes a pair of recoil units 50 such as, e.g., an elastic string or cylindrical coil spring, which may be provided through or along the stackable covers 31S. Therefore, such recoil units 50 may stretch and extend to their stressed states, and then unstretch and recoil back to their unstressed states. The system 30 may also include one or more regulators 32R to regulate stacking and/or unstacking of such stackable covers 31S. For example, one regulator 32R may be arranged to collect and push the covers 31S on top of a stack, to bias such a stack downward so as to increase friction force between the covers 31S and stack, and/or to provide force resisting the covering force, thereby preventing such covers 31S in the stack from being partially unstacked by the covering force. In contrary, another regulator 32R may be arranged to catch outgoing edges of the covers 31S on top of the stack, to provide resistance force, and/or to regulate the unstacking of the covers 31S. Thus, the stackable cover 31S disposed on top of the stack may be unstacked only when such a covering force may exceed the resistance forces generated by the regulators 32R. Further characteristics of the regulators 32R and housing 32 may be found in the aforementioned co-pending application.

In operation, the stackable covers 31S are disposed in their off-states, while the recoil units 50 are disposed in their unstressed states. As the covering force pulls the first end 33A in the covering direction, the top cover 31S of the stack is pulled away out of the stack toward its on-state, while the regulators 32R move the next cover 31S to the top of the stack. As such covering force continues to pull the first end 33A along the covering direction, the next cover 31S unstacks and moves along the same direction. The sequential unstacking of the covers 31S continues until the cover member moves to its fully on-state and at least a substantial number of such covers 31S unstack out of the housing 32 and/or when the user or actuator member ceases to apply the covering force. During the covering movements of the covers 31S, the recoil units 50 are stretched toward their stressed state and store at least a portion of the energy of such force, while exerting a recoil force in an opposite direction. As the covers 31S move to their on-states and cover a preset portion of the gap, the recoil units 50 are stretched to their stressed state, store a greater portion of the energy, and exert stronger recoil force. As the covering force ceases to apply, the recoil units 50 release the stored energy so as to pull the covers 31S back to the stack along the uncovering direction. Thereafter, the stackable covers 31S return to their off-state and uncover the preset portion of the gap as the recoil units 50 consume all or most of the stored energy and/or when the first end 33A is restrained by the holder 382. Other configurational and/or operational characteristics of the force generating member 50 shown in FIG. 9C are similar or identical to those of FIGS. 9A and 9B.

Configurational and/or operational variations and/or modifications of the above embodiments of the exemplary systems having the foregoing force generating members of FIGS. 9A 9C also fall within the scope of this invention.

First of all, the force generating member may include any number (including zero) of the above elastic and viscous units. When multiple elastic and/or viscous units are provided, such units may be mechanically coupled to each other in series and/or parallel fashions so as to provide desirable force storing and/or releasing characteristics. Disposition of the elastic and/or viscous units may also vary depending upon selection of such force storing and/or releasing characteristics, detailed configuration of the cover system, and so on. Thus, such elastic and/or viscous units may be disposed outside the housing, along multiple sections of the cover member, between the holder and first end of the cover member, and so on.

The force generating members including various conventional elastic and/or viscous units may be disposed in various positions of the system, door, and/or frame. Such elastic and/or viscous units are generally disposed along the covering and/or uncovering directions thereof to utilize the covering and/or uncovering forces in order to operate the force generating member between the stressed and unstressed states. When such a member includes at least one conventional force transmitting device, however, such elastic and/or viscous units may be aligned off from such covering and/or uncovering directions. As long as at least a portion of the covering and/or uncovering forces may be transmitted to the force generating member and the stored energy may be delivered from such a member to the cover, detailed alignment of such units may not be material to the scope of the present invention.

The force generating member may also be arranged to include multiple force generating units coupled to each other in series and/or parallel modes or, alternatively, the system may include multiple force generating members to provide desirable force storing and/or releasing characteristics. Detailed configuration and/or arrangements of such multiple force generating members and/or force generating units, therefore, may not be critical to the scope of the present invention as far as such members may be arranged to provide at least a portion of the energy required for the covering or uncovering force.

The recoil unit may store and release energy by various embodiments. For example, the recoil unit may be triggered to recoil (e.g., extending from its compressed stressed state or retracting from its stretched stressed state) and release such stored energy in order to provide the covering force in response to one or more events such as, e.g., when the door begins to open, the cover receives an input signal, and so on. The recoil unit may then be arranged to recoil to their unstressed state and to consume all or at least a substantial portion of energy stored therein as the cover moves to its (fully) on-state and covers a preset portion of the gap. The recoil unit may also be triggered to be stressed (e.g., extended, stretched or compressed toward its stressed state) and begin to store the energy in response to one or more events supplying energy thereto such as, e.g., as the door begins to close, when the cover receives another input signal, and the like. The recoil unit may then deform to its fully stressed state and store a maximum amount of such energy as the cover moves to its fully off-state and uncovers a preset portion of the gap, thereby getting ready to supply another covering force for the next cycle. In a reverse example, the recoil unit may be arranged to store energy while recoiling to its unstressed state, and to release such stored energy while deforming to its stressed state.

Contrary to the foregoing embodiments, the force generating member may also be arranged in a reverse fashion so that its recoil unit may be compressed (or stretched) to its stressed state when the cover is in its off-state and recoil back to its unstressed state when the cover member is in its on-state. In addition, the recoil unit may also be arranged to have its unstressed state when the cover is disposed between its on- and off-states or when the door is disposed between its open and closed positions. In the alternative, the recoil unit may be arranged to be in a partially stressed or unstressed state as the cover member is in its off- or on-position. Therefore, selection of the unstressed and/or stressed states of the force generating member is not generally critical to the scope of this invention as long as the force generating member is arranged to store at least a portion of the energy supplied thereto by the user or actuator member and to release the stored energy to generate at least a portion of the covering and/or uncovering movement of the cover. A designer may further select one of such operating modes of the above force generating members to release the stored energy to automatically move the cover from its on- to off-state or vice versa.

The foregoing recoil units may have configurations different from those described heretofore. For example, the recoil unit may include at least one elastic structure which may include non-elastic materials arranged to exhibit apparent elasticity through such a structure. When desirable, the force generating member may include at least one break unit arranged to lock the recoil unit in its stressed state such that the recoil unit may hold its energy stored therein. As the brake unit receives the input signal to release such energy, such a unit may disengage the recoil unit to release such energy and generate the covering or uncovering movement of the cover. Detailed configurations of such a break unit generally depend upon operational and/or configurational characteristics of the cover member.

Conventional mass-spring-dash pot analogs may be employed to simulate and design desirable dynamic characteristics of the cover so as to exhibit desirable displacements, speeds, accelerations, and/or oscillations which may be at least partially determined by masses of the cover and door, spring constants of the recoil unit, viscosities of the viscous unit, and the like. Accordingly, the recoil and/or viscous units may be connected in series or in parallel with each other and any number of such units may be included in the force generating member. It is appreciated that any number of recoil units may be disposed in almost any locations of the system, that such recoil and/or viscous units may be used in any number and/or arrangement as long as such units may generate at least a portion of one of the covering and uncovering forces in response to the other of such forces, and that such units may not interfere the covering and uncovering movements of the cover and/or opening and closing movements of the door. It is also appreciated that the force generating member may not require any viscous unit when the door-frame assembly has a door check to dampen the movements of the cover and/or door.

As described herein, the door safety system of this invention may incorporate various guides and actuator members in order to actuate various covers between their off- and on-state. In general, mechanisms and operations of such guides and actuator members are well known in the relevant art and not be material to the scope of the present invention. Further details of such guides and actuator members may be found in the aforementioned co-pending application.

Unless otherwise specified, various features of one embodiment of one aspect of the present invention may apply interchangeably to other embodiments of the same aspect of this invention and/or embodiments of one or more of other aspects of this invention.

It is to be understood that, while various aspects and embodiments of the present invention have been described in conjunction with the detailed description thereof, the foregoing description is intended to illustrate and not to limit the scope of the invention, which is defined by the scope of the appended claims. Other embodiments, aspects, advantages, and modifications are within the scope of the following claims.

What is claimed is:

1. A door safety system for a door which is configured to movably couple with a frame, to rotate about a rotating axis defined on said frame between at least one open position and at least one closed position, to define a front surface, a rear surface, a rear end disposed close to said rotating axis, and a front end opposite to said rear end, and to form a gap between said frame and rear end of said door when said door moves away from said closed position toward said open position, said safety system comprising:
at least one cover member which is configured to be coupled to at least one of said frame and door and to operate from at least one off-state to at least one on-state and vice versa when said door respectively moves from said closed position to said open position and vice versa, wherein at least a portion of said cover member is configured to be disposed adjacent to said frame and rear end of said door in said off-state and to cover (or isolate, fill, extend across, block access to) at least a portion of said gap in said on-state.

2. The safety system of claim 1, wherein at least a portion of said cover member is configured to be fixedly incorporated into said door.

3. The safety system of claim 1, wherein at least a portion of said cover member is configured to be fixedly incorporated into said frame.

4. The safety system of claim 1, wherein said door is configured to form at least one indentation in said rear end and to receive and retain at least a portion of said cover member in said indentation in at least one of said off- and on-states of said cover member.

5. The safety system of claim 1, wherein said frame defines a coupling end to face said rear end of said door and is configured to form at least one indentation in said coupling end and to receive and to retain at least a portion of said cover member inside said indentation in at least one of said off- and on-states of said cover member.

6. The safety system of claim 1, wherein said cover member includes at least one foldable cover which is configured to couple with at least one of said frame and door and wherein at least a portion of said foldable cover is configured to remain folded when said door is in said closed position, and then to be unfolded when said door moves away from said closed position, thereby covering at least a portion of said gap in said on-state.

7. The safety system of claim 6 further comprising a housing, wherein said housing is configured to couple with at least one of said frame and said door and wherein at least a portion of said foldable cover is configured to remain folded inside said housing when said door is in said closed position, and then to be unfolded out of said housing when said door moves away from said closed position.

8. The safety system of claim 1, wherein said cover member has at least one stackable cover which is configured to couple with at least one of said frame and door and wherein at least a portion of said stackable cover is configured to define a stack when said door is in said closed position, and then to be unstacked from said stack when said door moves away from said closed position, thereby covering at least a portion of said gap.

9. The safety system of claim 8 further comprising a housing, wherein said housing is configured to be coupled to at least one of said frame and door and wherein at least a portion of said stackable cover is configured to define said stack in said housing when said door is in said closed position, and then to be unstacked out of said housing when said door moves away from said closed position.

10. The safety system of claim 1, wherein said cover member includes at least one rollable cover and a roller, wherein said roller is configured to couple with at least one of said frame and door, and wherein at least a portion of said rollable cover is configured to remain rolled around said roller when said door is in said closed position, and then to be unrolled out from said roller when said door moves away from said closed position, thereby covering at least a portion of said gap.

11. The safety system of claim 10 further comprising a housing which is configured to couple with at least one of said frame and door and wherein at least a portion of said rollable cover is configured to remain rolled in said housing when said door is in said closed position, and then to be unrolled out of said roller and housing when said door moves away from said closed position.

12. The safety system of claim 1, wherein said cover member includes at least one slidable cover and wherein at least a portion of said slidable cover is configured to be coupled to at least one of said frame and door, to be disposed close to at least one of said frame and door when said door is in said closed position, and then to slide across at least a portion of said gap when said door moves away therefrom, thereby covering said portion of said gap.

13. The safety system of claim 12 further comprising a housing which is configured to couple with at least one of said frame and door and wherein at least a portion of said slidable cover is configured to be disposed inside said housing when said door is in said closed position, and then to slide out of said housing when said door moves away therefrom, thereby covering at least a portion of said gap.

14. The safety system of claim 1, wherein said cover member has at least one deformable cover and wherein at least a portion of said deformable cover is configured to be coupled to at least one of said door and frame, to be deformed between said frame and rear end of said door into its stressed configuration in said off-state, and then to restore its unstressed configuration and cover at least a portion of said gap in said on-state.

15. The safety system of claim 1, wherein said cover member has at least one deformable cover and wherein at least a portion of said deformable cover is configured to be disposed between said frame and said rear end of said door in its unstressed configuration in said off-state, and then to be deformed toward its stressed configuration and cover at least a portion of said gap in said on-state.

16. The safety system of claim 1, wherein said cover member is configured to operate between said states according to a temporal relation with said door moving between said positions, wherein at least a portion of said cover member is configured be disposed adjacent to at least one of said frame and door in said off-state and to cover at least a portion of said gap in said on-state, and wherein said temporal relation is configured to at least partially control timings of operations of said cover member between said states in relation to timings of movements of said door between said positions.

17. The safety system of claim 1, wherein said cover member is configured to operate between said states according to a spatial relation with said door moving between said positions, wherein at least a portion of said cover member is configured be disposed adjacent to at least one of said frame and door in said off-state and to cover at least a portion of said gap in said on-state, and wherein said spatial relation is configured to at least partially determine paths of said cover member between said states in relation to paths of movements of said door between said positions.

18. The safety system of claim 1, wherein said cover member is configured to operate between said states through at least one cover driving force applied thereto based on a complementary relation between said cover driving force and at least one door driving force moving said door between said positions, wherein at least a portion of said cover member is configured be disposed close to at least one of said frame and door in said off-state and then to cover at least a portion of said gap in said on-state, and wherein said complementary relation is configured to at least partially determine at least one of timings, directions, and amplitudes of operations of said cover member between said states as well as at least one of timings, directions, and amplitudes of movements of said door between said closed and open positions.

19. A door-frame assembly comprising:
a frame;
a door which is configured to be disposed in said frame, to move between at least one closed position and at least one open position about a rotating axis provided near said frame, to have a rear end for being disposed adjacent to said rotating axis and a front end disposed opposite to said rear end and which is capable of defining a gap between said frame and rear end of said door when said door couples with said frame and when said door moves away from said closed position; and
at least one deformable cover disposed between said frame and rear end so as to prevent a mechanical damage to an object disposed between said frame and rear end when said door suddenly moves to said closed position.

20. A method of covering at least a portion of a gap with at least one cover member, wherein said gap is formed between a coupling end of a frame and a rear end of a matching door, defined closer to a rotating axis of said door as said door moves away from its closed position, said method comprising the steps of:
installing at least one cover member near at least one of said ends;
maintaining at least a portion of said cover member in one shape (or size) when said door is in said closed position; and
changing at least one configuration of said portion of said cover member to another shape (or size), thereby covering said portion of said gap by said portion of said cover member when said door moves away from said closed position and forms said gap.
